(19) United States
(12) Patent Application Publication
(10) Pub. No.: US 2026/0267002 A1
(43) Pub. Date: Sep. 10, 2026

(54) SYSTEMS AND METHODS FOR A PORTABLE ROBOT WITH COLLAPSIBLE TOWER AND SENSOR PROTECTION

(71) Applicant: Brain Corporation, San Diego, CA (US)

(72) Inventors: Joseph Cognato, San Diego, CA (US); Daniel Vandewiele, San Diego, CA (US); Matthew Atlas, San Diego, CA (US); Joe Fernando Nunez, San Diego, CA (US); Jeremiah Cox, San Diego, CA (US)

(73) Assignee: Brain Corporation, San Diego, CA (US)

(21) Appl. No.: 19/558,185

(22) Filed: Mar. 5, 2026

Related U.S. Application Data
(60) Provisional application No. 63/768,622, filed on Mar. 7, 2025.

(51) Int. Cl. G01S 17/894; G01S 7/481; G01S 7/497; G01S 17/86; G06T 7/33

(52) U.S. Cl. CPC G01S 17/894; G01S 7/4813; G01S 7/4972; G01S 17/86; G06T 7/33; G06T 2207/20084; G06T 2207/20212

(57) ABSTRACT

A robotic system for indoor mapping includes a base with a differential drive and a collapsible tower comprising a plurality of tower sections foldable at multiple joints. A folding mechanism transitions the tower between an extended configuration and a collapsed configuration in which the tower lies substantially flush with the base. A plurality of cameras are mounted along the tower and vertically aligned with a wheel axis of the differential drive such that the cameras rotate in place without lateral translation when the base turns, reducing image distortion. A 3D LiDAR sensor having a dome-like shape protrudes from the tower and is received within a protective cavity formed in an adjacent tower section when the tower is collapsed. A processor executes instructions to obtain image data and range data for mapping, navigation, and self-calibration.

### CROSS-REFERENCE TO RELATED APPLICATIONS

This application claims the benefit of priority to U.S. Provisional Application No. 63/768,622, filed on Mar. 7, 2025, the entire contents of which are hereby incorporated by reference in their entirety for all purposes.

### TECHNICAL FIELD

The present disclosure relates to a portable robotic system with a collapsible tower for sensor protection and efficient indoor mapping.

### BACKGROUND

In recent years, the use of robots for various applications such as indoor mapping, navigation, and image collection has gained significant traction. Practical applications may include the construction of indoor maps where other technologies such as global positioning systems (“GPS”) lack sufficient resolution, or inventory scanning where robots sense objects in the environment (e.g., products in a store) and/or localize them onto a map. These robots are often equipped with advanced sensors like cameras and LiDAR to perform tasks with high precision and efficiency. However, the portability and protection of these sensors remain a challenge. Traditional robots used for indoor mapping or other tasks like shelf scanning often incorporate planar LiDAR sensors, which, while cost effective, can be prone to damage if not adequately protected. Additionally, these robots can be bulky and difficult to transport, leading to increased shipping costs and logistical challenges. Conventional LiDAR sensors, including 2D and 3D LiDAR, are commonly used in these applications.

While 2D LiDAR sensors provide a flat, two-dimensional view, they can be limited in capturing the full spatial context of an environment and may require multiple 2D LiDAR sensors to fully capture the necessary area around the robot to ensure safe navigation. On the other hand, 3D LiDAR sensors offer a more comprehensive view of the environment by capturing range measurements across a horizontal and vertical axis, but can be more susceptible to damage, such as scratching, due to their design, which may cause the sensor and overall robotic system to malfunction. Both types of sensors require careful handling and protection to maintain their functionality and accuracy.

The need for more efficient and portable robotic solutions is evident as industries seek to optimize operations and reduce costs. Robots that can be easily transported and deployed in various locations without compromising the integrity of their sensors are highly desirable. This is particularly important in environments like grocery stores or warehouses, where robots need to navigate tight spaces and capture detailed imagery of tall shelves. Portable robots may also be useful for mapping new spaces, such as new buildings, wherein there may not be a need to continuously map the space as in a grocery store. While some conventional robots, such as drones, may be transformed into a portable mode, they often require special sensor coverings or casings to protect the sensors from damage during transport. Accordingly, there is a need in the art for a portable robot which is designed to protect its sensors from damage during transport.

The present disclosure addresses several specific technical problems in the field of mobile robotic systems. First, conventional portable robots lack an integrated mechanical solution for protecting protruding sensors, such as 3D LiDAR sensors with dome-like lenses, during transportation and storage, leading to sensor damage, loss of calibration, and costly repairs or replacements. Second, existing robots that utilize collapsible or foldable structures for portability do not coordinate the folding geometry of the tower with the sensor placement to automatically encapsulate the sensor within a complementary protective cavity upon folding, thereby requiring separate sensor covers, cases, or manual protective procedures that increase deployment time and the risk of human error. Third, conventional indoor mapping robots that employ 3D LiDAR sensors lack an integrated self-calibration mechanism that leverages the sensor's ability to detect a known static portion of the robot body to verify sensor alignment without external calibration targets or equipment, resulting in undetected calibration drift after transportation. The robotic system and methods disclosed herein solve these technical problems by providing a collapsible tower architecture in which the folding geometry of the tower sections is specifically designed so that a cavity formed in one tower section automatically and precisely encapsulates the protruding 3D LiDAR sensor on an adjacent tower section upon folding, thereby providing passive sensor protection without additional components or operator intervention. Additionally, the disclosed self-calibration method provides an integrated approach to detecting sensor misalignment by comparing current range measurements of known static robot surfaces against stored reference values, thereby enabling the robot to autonomously verify and compensate for calibration drift immediately after deployment.

### SUMMARY

The robotic system for indoor mapping disclosed herein may include a robot with a base and a tower that can be collapsed at multiple joints to reduce the robot's overall volume. The tower may integrate with the base when folded. A folding mechanism may be attached to the tower, allowing it to fold and align with the top of the base. This folding mechanism could include a hinge mechanism, such as a piano hinge, butt hinge, or continuous hinge, which facilitates the folding process. Additionally, other mechanisms like telescopic systems or sliding tracks can enable the tower to fold and collapse on itself in a compact configuration from an extended configuration. The system can have multiple cameras along the tower's side to capture visual data, enabling orthographic views and panoramic stitching of objects.

A 3D LiDAR sensor with a dome-like shape may be attached to the tower. The dome-like shape necessitates the 3D LiDAR sensor protrude outward from the robot body. The robot may also include a handle to assist with lifting, picking up, and repositioning, and it can be compatible with a transportation container for storage and shipping. The robot may be lightweight and transportable, making it easy to move. The tower may fold at a minimum of three locations and consist of at least three distinct sections, where the first section can fold clockwise onto the second section, the second section can fold counterclockwise with the third section, and the third section can fold counterclockwise onto the base. In other words, the second and the third sections of the tower fold in the first direction (i.e., counterclockwise), and the second section folds in the second direction (i.e., counterclockwise). The folding mechanism may enable the tower to collapse and fold onto the base and into a partitioned section of the base. The tower may include cameras spaced along one or both sides of the tower and that are perpendicular to the base of the robot and facing away from the forward direction of the robot as traveled . The 3D LiDAR sensor may be positioned on the front-facing side of the tower and protected by a cavity when a section of the tower is collapsed onto itself. The cavity may be formed by a portion of the base when the tower is collapsed and designed to prevent damage to the 3D LiDAR sensor during transportation and storage. The cavity may be sized to fit the dome-like shape of the 3D LiDAR sensor.

The robot may be capable of autonomously navigating and localizing within an environment and may be able to follow a predefined, trained, or (pseudo-)random path for mapping.

The method for indoor mapping using the robotic system may involve providing a robot with a base, a collapsible tower, a folding mechanism, multiple cameras, and a 3D LiDAR sensor. The tower may be folded at several locations using the folding mechanism to minimize the robot's overall volume, allowing it to align with the top of the base. The cameras may capture visual data for orthographic views and panoramic stitching of objects. The 3D LiDAR sensor may sense parts of the robot for self-calibration and diagnostics.

The method may also involve lifting, picking up, and repositioning the robot using a handle, and storing the robot in a transportation container for storage and shipping. The robot may be lightweight and transportable, facilitating easy movement. The folding design enables the robot to minimize its volume for easier transportation via ground or air. Folding the tower may involve folding it at a minimum of three locations. The tower may have at least three distinct sections, where the first section can fold clockwise onto the second section, the second section can fold counterclockwise with the third section, and the third section can fold counterclockwise onto the base. The folding mechanism may enable the tower to collapse and fold onto the base. The cameras may be evenly spaced along the tower's side. The 3D LiDAR sensor may be positioned on the front-facing side of the tower. The method may include protecting the 3D LiDAR sensor with a cavity when a section of the tower is collapsed onto itself. The cavity may be formed by a portion of the base when the tower is collapsed. The cavity may be designed to prevent damage to the 3D LiDAR sensor during transportation and storage. The cavity may be sized to fit the dome-like shape of the 3D LiDAR sensor.

Each step of the methods disclosed herein is performed by, or directly tied to, specific physical hardware components of the robotic system. The capturing of visual data is performed by the plurality of cameras, which are physical image sensors disposed at specific locations along the tower. The sensing for self-calibration and diagnostics is performed by the 3D LiDAR sensor, which is a physical electro-optical ranging device that emits infrared laser beams and detects their reflections. The folding of the tower is a physical mechanical operation performed by the folding mechanism, which comprises physical pivot joints or hinge mechanisms connecting the tower sections. The protection of the sensor by the cavity is a physical encapsulation resulting from the mechanical alignment of a concave cavity formed in the tower section over the dome-like sensor on the tower section. The methods disclosed herein are therefore not directed to abstract data manipulation but rather to the physical operation and reconfiguration of a specific robotic system having a defined mechanical structure.

In some aspects, the techniques described herein relate to a robotic system for indoor mapping, including: a base including a differential drive having a wheel axis; a tower coupled to the base and including a plurality of tower sections including a lower section and at least one upper section, the tower being collapsible at a plurality of joints between adjacent tower sections; a folding mechanism configured to fold the tower from an extended configuration into a collapsed configuration in which the tower lies substantially flush with a top of the base; a plurality of cameras mounted to the tower along a line that is vertically aligned with the wheel axis, the plurality of cameras being oriented substantially perpendicular to a direction of travel of the robotic system such that rotation of the base about the wheel axis causes the plurality of cameras to rotate in place without substantial lateral translation of corresponding fields of view; a three-dimensional (3D) LiDAR sensor mounted to the robotic system; a memory including computer readable instructions stored thereon; and at least one processor configured to execute the computer readable instructions to cause the robotic system to: obtain image data from the plurality of cameras while the robotic system traverses a path adjacent to one or more objects; and obtain range data from the 3D LiDAR sensor while the robotic system traverses the path.

In some aspects, the techniques described herein relate to a robotic system, further including: a cavity is formed in one of the tower sections, and wherein, the 3D LiDAR sensor is mounted to a front-facing side of the tower and has a dome-like shape that protrudes outward from the tower; and the cavity is positioned such that, in the collapsed configuration, the cavity at least partially receives the dome-like shape of the 3D LiDAR sensor to protect the 3D LiDAR sensor during transportation and storage.

In some aspects, the techniques described herein relate to a robotic system, wherein the instructions further cause the at least one processor to generate an orthographic composite image of the one or more objects by concatenating pixel regions extracted from a plurality of captured images, each pixel region corresponding to a central band of an image captured at substantially normal incidence.

In some aspects, the techniques described herein relate to a robotic system, wherein the instructions further cause the at least one processor to: identify keypoints in overlapping regions of the image data captured by at least one of the plurality of cameras; compute a geometric transformation based on the keypoints; and generate a panoramic image of the one or more objects by aligning and blending the image data according to the geometric transformation.

In some aspects, the techniques described herein relate to a robotic system, wherein the instructions further cause the at least one processor to: cause the plurality of cameras to capture an image of at least one object at a current distance; determine a focus metric of the image using a Laplacian-based variance calculation or a trained machine learning model; compare the focus metric to a focus threshold; and in response to the focus metric being below the focus threshold, adjust a navigating distance between the robotic system and the at least one object and cause the plurality of cameras to recapture the image.

In some aspects, the techniques described herein relate to a robotic system, wherein: the memory stores reference range measurements associated with at least one known static portion of the robotic system; and the instructions further cause the at least one processor to: obtain range data from the 3D LiDAR sensor including range measurements to the at least one known static portion of the robotic system; compare the range measurements to the reference range measurements; determine, based on the comparison, whether the 3D LiDAR sensor is misaligned relative to the base; and in response to determining that the 3D LiDAR sensor is misaligned, apply a corrective transformation to subsequent range data or generate a diagnostic alert indicating a calibration condition.

In some aspects, the techniques described herein relate to a method for operating a robotic system for indoor mapping, the method including: 8. providing a robotic system including: a base including a differential drive having a wheel axis, a tower coupled to the base and including a plurality of tower sections including a lower section and at least one upper section, the tower being collapsible at a plurality of joints between adjacent tower sections, a folding mechanism configured to fold the tower from an extended configuration into a collapsed configuration in which the tower lies substantially flush with a top of the base, a plurality of cameras mounted to the tower along a line that is vertically aligned with the wheel axis, the plurality of cameras being oriented substantially perpendicular to a direction of travel of the robotic system such that rotation of the base about the wheel axis causes the plurality of cameras to rotate in place without substantial lateral translation of corresponding fields of view, a three-dimensional (3D) LiDAR sensor mounted to the robotic system, and a memory including computer readable instructions stored thereon; navigating the robotic system along a path adjacent to one or more objects while the tower is in the extended configuration; obtaining, by the plurality of cameras, image data of the one or more objects while the robotic system traverses the path; and obtaining, by the 3D LiDAR sensor, range data while the robotic system traverses the path.

In some aspects, the techniques described herein relate to a method, wherein the robotic system further includes: a cavity formed in one of the tower sections, and wherein, the 3D LiDAR sensor is mounted to a front-facing side of the tower and has a dome-like shape that protrudes outward from the tower; and the cavity is positioned such that, in the collapsed configuration, the cavity at least partially receives the dome-like shape of the 3D LiDAR sensor to protect the 3D LiDAR sensor during transportation and storage.

In some aspects, the techniques described herein relate to a method, further including: generating, by at least one processor executing the computer readable instructions, an orthographic composite image of the one or more objects by concatenating pixel regions extracted from a plurality of captured images, each pixel region corresponding to a central band of an image captured at substantially normal incidence.

In some aspects, the techniques described herein relate to a method, further including, by at least one processor executing the computer readable instructions, identifying keypoints in overlapping regions of the image data captured by at least one of the plurality of cameras; computing a geometric transformation based on the keypoints; and generating a panoramic image of the one or more objects by aligning and blending the image data according to the geometric transformation.

In some aspects, the techniques described herein relate to a method, further including, by at least one processor executing the computer readable instructions: causing the plurality of cameras to capture an image of at least one object at a current distance; determining a focus metric of the image using a Laplacian-based variance calculation or a trained machine learning model; comparing the focus metric to a focus threshold; and in response to the focus metric being below the focus threshold, adjusting a navigating distance between the robotic system and the at least one object and causing the plurality of cameras to recapture the image.

In some aspects, the techniques described herein relate to a method, wherein, the memory stores reference range measurements associated with at least one known static portion of the robotic system; and the method further includes, by at least one processor executing the computer readable instructions: obtaining range data from the 3D LiDAR sensor including range measurements to the at least one known static portion of the robotic system; comparing the range measurements to the reference range measurements; determining, based on the comparison, whether the 3D LiDAR sensor is misaligned relative to the base; and in response to determining that the 3D LiDAR sensor is misaligned, applying a corrective transformation to subsequent range data or generating a diagnostic alert indicating a calibration condition.

In some aspects, the techniques described herein relate to a method, further including folding the tower from the extended configuration into the collapsed configuration using the folding mechanism, wherein folding the tower causes the tower to become flush with the top of the base.

In some aspects, the techniques described herein relate to a method, further including protecting the 3D LiDAR sensor during transportation and storage, wherein folding the tower causes a cavity formed in one of the tower sections to automatically move over at least a portion of the 3D LiDAR sensor.

### BRIEF DESCRIPTION OF THE DRAWINGS

FIG. 1 shows a robotic system with collapsable tower in an extended configuration, according to an exemplary embodiment.

FIG. 2 shows the robotic system of FIG. 1 in a collapsed and folded configuration.

FIG. 3 shows a cross-section of different sections of the tower of the robotic system of FIG. 1.

FIG. 4 shows the robotic system of FIG. 1 as the first and second sections of the tower pivot with respect a y-axis.

FIG. 5 shows the robotic system of FIG. 1 with the first and second sections of the tower collapsed onto the third section of the tower as the third section of the tower is in a straight, non-collapsed configuration.

FIG. 6 shows the robotic system of FIG. 1 with the first, second and third sections of the tower collapsed or folded with respect to the base of the robot such that the entire tower is flush with the base of the robotic system.

FIG. 7 illustrates the various components of the robotic system of FIG. 1 in a block form configuration.

FIG. 8 illustrates a method of operating the robotic system of FIG. 1 as it optimizes compactness and functionality through collapsible components and sensors.

FIGS. 9(i)-(iii) illustrates another embodiment of the robotic system illustrated in FIG. 1 that is retrofitted onto a pushcart.

FIG. 10 illustrates a method of configuring the robotic system disclosed herein to capture images of objects and features within an environment.

FIGS. 11A-B illustrate alternative embodiments of the robotic system of the present disclosure.

All Figures disclosed herein are © Copyright 2026 Brain Corporation. All rights reserved.

### DETAILED DESCRIPTION

The present disclosure can be understood more readily by reference to the instant detailed description, examples, and claims. The present disclosure is not limited to the example embodiments and/or methods disclosed herein, which may, of course, vary. It is also to be understood that the terminology used herein is for the purpose of describing particular embodiments only and is not intended to be limiting. Unless defined otherwise, all technical and scientific terms used herein have the same meaning as commonly understood by one of ordinary in the art.

The disclosure provides a robotic system designed for indoor mapping, which may include a collapsible tower integrated with a base. The collapsible tower can be folded at multiple joints, allowing the robot to minimize its overall volume for efficient storage and transportation. A folding mechanism may facilitate the tower's collapse, ensuring it becomes flush with the base in the folded configuration.

The robotic system may incorporate a plurality of cameras along the tower's side, enabling the capture of visual data for orthographic views and panoramic stitching of objects.

Orthographic views refer to a method of capturing images where the perspective distortion is minimized, allowing for accurate representation of objects without the effects of perspective. Each pixel of an orthographic image is captured at substantially normal/orthogonal incidence, whereas in typical photography pixels near the edges of photos are sensed at an angle. This is particularly useful in mapping and surveying applications where precise measurements and representations are required.

Panoramic stitching, on the other hand, involves combining multiple images taken from different angles to create a wide-angle or 360-degree view of an environment. A panoramic image may also comprise a plurality of images captured at different locations which are overlaid and combined into a composite image. This technique is beneficial for creating comprehensive visual maps of indoor spaces, such as tall shelves in a grocery store, by providing a seamless and continuous image that covers a larger area than a single camera shot could capture. The combination of orthographic views and panoramic stitching allows the robotic system to generate detailed and accurate visual data, enhancing its capability to map and navigate complex indoor environments effectively.

According to at least one non-limiting exemplary embodiment, the generation of orthographic views by the robotic system 100 may be achieved as follows. As the robot 100 navigates along a path parallel to an object, such as a shelf in a grocery store or warehouse, each camera 102 disposed along the side of the tower 101 captures a sequence of images at regular intervals. Because the cameras 102 are vertically aligned with the wheel axis 114 of the differential drive and face substantially perpendicular to the direction of travel, each captured image represents a narrow vertical strip of the object captured at approximately normal incidence. A processor, which may be located on the robotic system 100 or on an external computing device communicatively coupled thereto, may extract the central column or a narrow central band of pixels from each captured image, where perspective distortion is minimized. These extracted strips may be sequentially concatenated in the direction of travel to form a composite orthographic image of the object. In some embodiments, the processor may apply homography transformations or affine corrections to each image prior to stitching to account for minor angular deviations or lens distortion effects. The panoramic stitching process may employ feature matching algorithms, such as Scale-Invariant Feature Transform (SIFT), Speeded-Up Robust Features (SURF), or Oriented FAST and Rotated BRIEF (ORB), to detect and match corresponding keypoints between overlapping regions of sequential images captured by the same camera 102 or between images captured by vertically adjacent cameras 102. Based on the matched features, the processor may compute a geometric transformation, such as a homography matrix, that aligns adjacent images. The aligned images may then be blended using a multi-band blending technique or a simple weighted average in the overlap region to produce a seamless panoramic composite image.

Additionally, the robotic system 100, or alternatively referred to herein as robot, may include a 3D LiDAR sensor, characterized by a dome-like shape. The 3D LiDAR dome protrudes from a front facing surface of a tower coupled to the base of the robotic system in order to facilitate transmission of its infrared beams into the environment. The 3D LiDAR sensor may be coupled to the tower in such a way as to sense portions of the robot for self-calibration and diagnostics and also for further capturing the surrounding of the robotic system as it navigates a route. The 3D LiDAR sensor may be protected by a cavity formed in a portion of the tower when the tower is collapsed onto itself, thereby, safeguarding the LiDAR sensor during transport.

The robot may be lightweight and transportable, featuring handles for easy lifting and repositioning. The design may allow the robot to autonomously navigate and localize within an environment for mapping purposes. The robot may follow pre-defined paths, trained paths, or may explore its environment in a (pseudo-)random order. The system can be compatible with transportation containers, enhancing its portability and reducing shipping costs.

As used herein, the term 'lightweight' refers to the robotic system 100 having a total weight that permits a single human operator to lift, carry, and reposition the robotic system 100 without mechanical assistance. In at least one exemplary embodiment, the robotic system 100 in its collapsed configuration may weigh between approximately 20 pounds and 60 pounds, inclusive of the base 106, the tower 101 with all sections 101A, 101B, and 101C, the cameras 102, the 3D LiDAR sensor 108, internal power supply (such as a rechargeable lithium-ion or lithium-iron-phosphate battery), and onboard electronics. The weight may be further reduced in embodiments where the power supply is modular and transported separately from the robotic system 100. The term 'transportable' refers to the robotic system 100 being capable of being shipped via standard ground or air parcel carriers (e.g., within a case having dimensions no greater than approximately 50 inches in its longest dimension) and fitting within the cargo area of a standard passenger vehicle or light commercial vehicle.

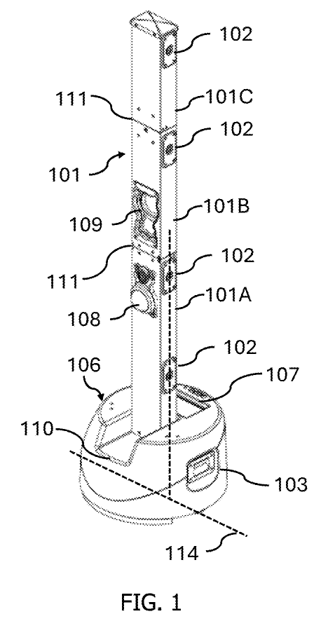

Referring now to FIG. 1, the technical drawing illustrates a collapsable tower 101 of a robotic system 100 designed for indoor mapping, according to an exemplary embodiment. The tower is composed of three distinct sections (from bottom to top): the first section 101A, the second section 101B, and the third section 101C. These sections are configured to fold in a manner that minimizes the overall volume of the robot, facilitating easy transport and storage as shown in the later figures. The tower integrates seamlessly with the base of the robot when collapsed, specifically folding into a groove 110 in the base 106 which is of approximately the same width and height dimensions as the section 101A. The collapsable tower 101, when extended as shown in FIG. 1, is also configured to position its cameras 102 at a height sufficient to capture images of shelves. Additionally, the use of a plurality of cameras and panoramic image stitching enables the creation of images of the shelves from an orthographic perspective. Some embodiments of the tower 101 may be taller or shorter than the one shown in FIG. 1 if the objects being captured are taller or shorter, respectively. These sections are designed to fold at multiple joints 111, allowing the tower to minimize the overall volume of the robot for efficient storage and transportation.

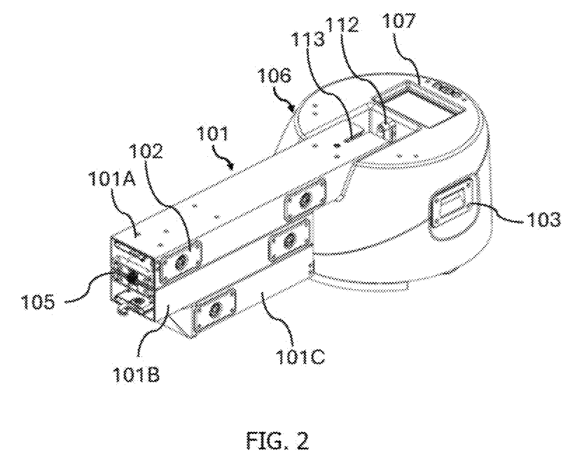

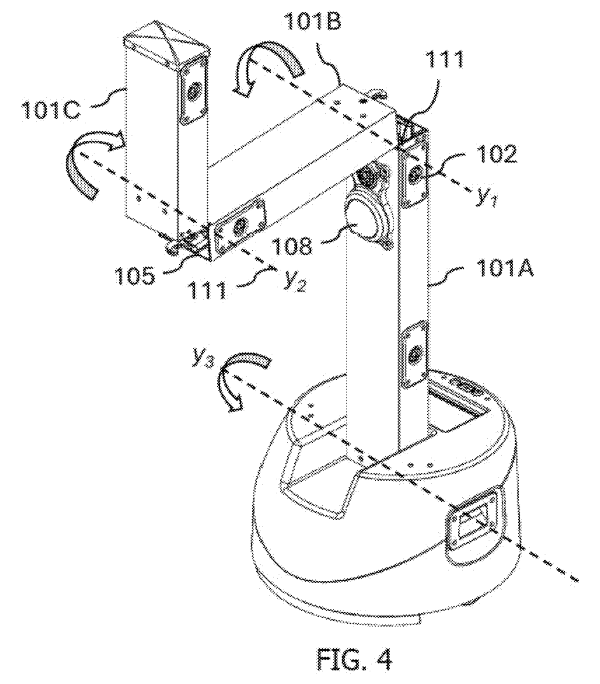

Section 101C of the tower 101 is positioned as the uppermost part of the tower 101, which folds onto section 101B in a clockwise direction with respect to its y2axis as further discussed below with respect to FIG. 4. Section 101B serves as the middle section, connecting the upper and lower sections, and folds onto section 101A in a counterclockwise direction with respect to its y1 axis as further disclosed below with respect to FIG. 4. Section 101A is the lowermost part of the tower, which integrates with the base of the robot. When the tower is collapsed, these sections fold onto each other, including lower section 101A to rotate counterclockwise direction, with respect to a y 3 axis as further disclosed below in to FIG. 4. The folding of the lower section 101A into the base 106, specifically into the groove 110, causes the lower section 101A to be flush with the top of the base 106, and, as such reducing the robot's footprint and ensuring a compact form factor as shown in FIG. 2. This design facilitates the robot's portability and protects the sensors during transportation. While three sections are shown, this is not a limiting feature; additional sections may be added onto the top of the tower as needed.

It is appreciated that terms such as clockwise and counter clockwise are in reference to the illustrated figures and not intended to be limiting, wherein one may appreciate that the rotation may be in the opposite direction when viewed from the other side.

In the upright or extended configuration, the lower section 101A of the tower includes a groove or slot 113 towards a bottom portion that engages with a pin 112 extending outward from the base 106. The groove 113 is seen more clearly in FIG. 2 when the robot is folded. This results in the lower section 101A to be secure in the upright position as the pin 112 and the slot 113 engage with each other.

Further, as illustrated in FIG. 1, the robot the front of the tower 101 is equipped with a 3D LiDAR sensor 108 at section 101A of the tower 101, which is essential for capturing visual data and enabling self-calibration and diagnostics. As shown and discussed before, the 3D LiDAR sensor 108 is designed with a dome-like shape that protrudes from the tower. The dome is further tilted at a slight (e.g., 5 – 10 degree) angle, allowing it to sense a portion of the robot’s base 106 for self-calibration. A cavity (109) is strategically designed at section 101B of the tower to protect the sensor 108 when the tower is collapsed, ensuring that the sensor remains undamaged during transport and storage. This cavity 109 is dimensioned to accommodate the dome-like shape of the 3D LiDAR sensor 108.

Additionally, the tower 101 is equipped with cameras 102 strategically placed along its side; however, the vertical configuration and arrangement of the plurality of cameras 102 is not limiting. These cameras are designed to capture images of shelves as the robot 100 travels along its route. The cameras (102) are recessed within a cavity and have protective grooves around them, which prevent damage during transportation. The cameras 102 may be recessed due to their smaller field of view as compared to the 3D LiDAR sensor 108, and therefore may be sufficiently protected by the recessing into the tower. The evenly spaced cameras 102 along the tower's side further enhance the robot's functionality by enabling orthographic views and panoramic stitching of objects. By being positioned on the side of the tower 101, the cameras 102 can effectively capture orthographic views and enable panoramic stitching of the objects they encounter, such as shelves in a grocery store, as the robot drives past the objects. Additionally, the cameras 102 are vertically aligned with the wheel axis 114 of the differential drive such that they do not translate when the base 106 rotates. The base 106 of the robot includes the differential drive configuration, comprising of two wheels that rotate independently, to allow the robot to turn in place, wherein the axis of the wheels (obstructed from view) is shown via dashed line 114 which intersects the vertical axis of the three cameras 102. This setup allows the robot 100 to create detailed visual maps of indoor spaces, providing comprehensive imagery that is essential for tasks like inventory management and spatial analysis while minimizing image distortion.

According to at least one non-limiting exemplary embodiment, the upper section 101C may include one or more special purpose cameras, such as upper reserve steel or bunker cameras for imaging displays that would not be suitable for orthographic view. Upper reserve steel cameras may be aimed upwards (e.g., around 20 – 45 degrees) to capture images of high-up shelves, such as those in large warehouses or certain bulk retailers, as it would be impractical to extend the tower 101 to a height sufficient to capture an orthographic image. Other displays may necessitate a bunker camera, which is a camera 102 aimed downward (around 20 – 60 degrees) from the top of the tower 101C. These cameras may be ideal for capturing images of flat displays, such as clothing arranged on a flat table or meat coolers wherein a photo from the side perspective would be highly distorted or not see most products behind the first row. These cameras may come as part of a separate attachable module or may be integrated into the tower section 102C. It may be further beneficial to ensure that the power supply is also modular to minimize degradation during transportation and to ensure safe transport, depending on the type of power supply (e.g., battery), as this scanning robot may spend the majority of its time traveling rather than operating.

The robotic system 100 also incorporates a 3D LiDAR sensor 108, which is described as being positioned on the front-facing side of the tower 101 in the robot’s 100 forward direction of travel. This sensor 108, with its dome-like shape, protrudes from the tower 101 to avoid obstruction of its infrared beams. In some embodiments, the LiDAR sensor 108 may also collect ranging measurements to portions of the robot 100 body, which should remain static assuming the sensor 108 also remains static (i.e., well calibrated), and thereby facilitate self-calibration and diagnostics. This method of self-calibration by detecting a portion of the robot body is also applicable to 2D LiDAR and depth cameras and may require these sensors also protrude from the body of the robot 100, wherein the folding design of the robot 100 may also be employed to protect these sensors as well.

The 3D LiDAR sensor is positioned on the front-facing side of the tower, allowing it to capture the environment around the robot as it navigates across a wide field of view. This placement ensures that the sensor can operate without obstruction, providing a wide (e.g., 180o – 270o) field of view in the vertical and horizontal axis for accurate mapping and navigation. Use of a singular 3D LiDAR sensor reduces the potential sensor failure points of the robot down to primarily the singular sensor, simplifying the mechanical design of the overall robot.

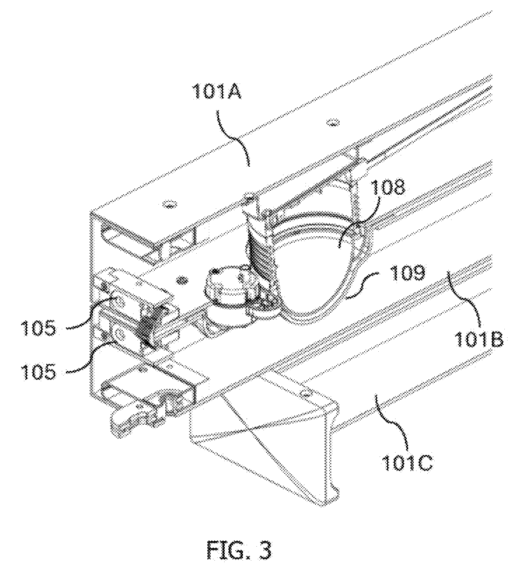

The design of the tower 101, specifically portion 101B, includes a cavity 109 which is designed to protect the 3D LiDAR 108 during transportation and storage. The cavity 109 is strategically formed to match the dome-like shape of the 3D LiDAR 108, ensuring that when the tower 101 is folded onto itself, the cavity 109 covers the LiDAR 108 and provides protection during transportation. A more detailed view of the cavity 109 covering the LiDAR 108 when the robot 100 is folded is provided in FIG. 3 below.

Advantageously, the robotic system depicted in FIG. 1 addresses and solves many of the challenges of portability by ensuring sensor protection, making it suitable for rapid deployment and relocation in different places.

Additionally, the robot includes handles 103 on either side of the base 106 of the robot 100 that assists in lifting and repositioning the robot, making it more user-friendly and portable. The handle 103 is positioned at roughly the center of mass of the overall robot when folded down such that it may be balanced when carried. The design of the collapsable tower, along with the integrated folding mechanism and sensor protection, addresses the primary objectives of portability and sensor safety. Other embodiments may include handle(s) in different locations, such as on top of the base 106 (e.g., where the user interface 107 is) and/or one or more handles on the lower tower section 101A. This configuration may enable lifting of the robot from the top and reduce the amount a human operator needs to bend over.

Referring now to FIG. 2, the drawing illustrates the robotic system 100 in a folded or collapsed configuration that is designed for indoor mapping, emphasizing portability and sensor protection. As shown in FIG. 2, such collapsing or folding of the tower 101 allows for it to become flush with the top of the base 106 once the tower 101 is completely folded, thereby reducing the robot's 100 volume when stored for transportation. The system features a collapsable tower 101 composed of multiple sections: an upper section 101C, a middle section 101B, and a lower section 101A. These sections are interconnected by joints, allowing the tower to fold efficiently, thereby minimizing the robot's 100 overall volume for easy transport and storage. The base 106 of the robot 100 supports the tower 101 and integrates with it when folded, ensuring a compact form factor that aligns with the system's goal of reducing shipping costs and enhancing portability. Although obscured from view, there may be one or more plastic or rubber pads or cushions in-between each fold to prevent long-term damage or scratches from vibrations.

As further illustrated in FIG. 2, the collapsible tower of the robotic system 100 is composed of three distinct sections: 101A, 101B, and 101C. These sections are designed to fold at multiple joints, allowing the tower 101 to minimize the overall volume of the robot 100 for efficient storage and transportation. Section 101C is positioned as the uppermost part of the tower, folding onto section 101B. Section 101B serves as the middle section, connecting the upper and lower sections, and folds onto section 101A. Section 101A is the lowermost part of the tower (101), which integrates with the base 106 of the robot 100. When the tower 101 is collapsed, these sections fold in a coordinated manner, becoming flush with the top of the base 106, thereby reducing the robot's 100 footprint and ensuring a compact form factor. This design facilitates the robot's 100 portability and protects the sensors during transportation.

The tower 101 is equipped with a folding mechanism that facilitates its collapse onto the base, ensuring the robot's compactness. Examples of folding mechanisms include hinge mechanisms, which allow components to pivot or fold along a fixed axis. Other examples are pivot joints, which enable rotational movement, and telescopic mechanisms, which allow sections to slide into one another, reducing length. These mechanisms are often used in applications where compactness and ease of deployment are essential are designed for achieving a collapsable design that protects the sensors during transport.

According to at least one non-limiting exemplary embodiment, the folding mechanism of the robotic system 100 may comprise one or more pivot joints located at the junctions between adjacent tower sections 101A, 101B, and 101C. Each pivot joint may include a stainless steel or aluminum alloy hinge pin having a diameter of approximately 4 millimeters to 10 millimeters, rotatably received within a pair of hinge knuckles integrally formed or fastened to the adjacent tower sections. The hinge knuckles may be secured to the tower sections via mechanical fasteners, such as machine screws, rivets, or press-fit pins, or via welding or adhesive bonding. In some embodiments, the pivot joints may further include a friction element, such as a wave spring washer or a detent mechanism, configured to provide a predetermined resistance to rotation. This friction element may hold the tower sections 101A, 101B, and 101C in a desired angular position during the folding or unfolding sequence, preventing uncontrolled free-swinging of the sections. The pivot joints at the junction between the lower section 101A and the base 106 may be configured to allow rotation about the y3 axis (as shown in FIG. 4), while the pivot joints between the lower section 101A and the middle section 101B allow rotation about the y1 axis, and the pivot joints between the middle section 101B and the upper section 101C allow rotation about the y2 axis. In alternative embodiments, the folding mechanism may comprise a combination of live hinges, geared hinges, or spring-loaded hinges that bias the tower sections toward either the extended configuration or the collapsed configuration, depending on the design requirements.

According to at least one non-limiting exemplary embodiment, a robot 100 may employ multiple different mechanical methods for extending the tower. For instance, in one exemplary embodiment, the upper section 101C may telescopically extend from the middle section 101B, wherein the middle section 101B may still fold over the lower section 101A to protect the sensor 108. In another example, the base 106 (specifically groove 110) may contain the cavity 109 fitted to protect the 3D LiDAR sensor 108 and the three tower sections 101B and 101C may extend telescopically from the lower section 101A, which folds onto the base as shown in FIG. 2.

The folding mechanism in the robotic system's tower may incorporate elements of these mechanisms to achieve the desired compactness. For example, the tower may have pivot joints at strategic locations, allowing each section to rotate and fold onto the next. This design ensures that the tower folds over the 3D LiDAR 108, thereby protecting the sensor 108, in addition to reducing the robot's 100 footprint for efficient storage and transport.

The robot 100 also includes a handle 103 on each side of the base 106 of the robot 100 for lifting and repositioning the robot 100. The handle 103 enhance the robot's 100 usability by allowing easy relocation and storage in a transportation container. The handle 103 may be located on one or both sides of the robot, positioned in such a way that it assists with lifting or picking up and repositioning the robot, such as near the center of mass of the folded-down robot shown in FIG. 2. Preferably the handle 103 is accessible while the robot is in a storage container such that it may be easily removed. This placement is near the center of mass of the robot, when in the folded configuration, to provide balance and ease of handling. Additionally, placing the handle 103 in the base 106 of the robot may prevent warping or bending of the tower 101 sections when being held as typically the base 106 is a considerable amount of the overall robot weight due to, inter alia, its motors and wheels.

Referring now to FIG. 3, the technical drawing illustrates the collapsible tower of the robotic system 100, emphasizing the folding mechanism and sensor protection features. In particular, FIG. 3 illustrates the cross-section of the tower in the collapsed configuration as shown in FIG. 2. The tower 101 is composed of three distinct sections labeled 101A, 101B, and 101C, each designed to fold at one or more joints (e.g., via couplings 105) to minimize the robot's overall volume. The 3D LiDAR sensor 108 is positioned on the lower section 101A and, when the robot 100 is in the folded configuration shown in FIG. 2, the dome structure of the LiDAR 108 rests within the concave cavity 109 that is formed in the middle section 101B.

The 3D LiDAR sensor 108 is prominently featured in the drawing. It is dome-shaped and protrudes from the tower 101, allowing it to capture a wide field of view necessary for effective indoor mapping. To protect this component during transport, a cavity 109 is incorporated into section 101B of the tower 101. The cavity 109 is strategically positioned to house the 3D LiDAR sensor 108 when the section 101B collapses or folds onto section 101A, thereby safeguarding it from potential damage. The cavity's 109 dimensions are specifically tailored to accommodate the dome-like shape of the sensor 108, ensuring a fit that prevents movement and impact during handling. Preferably the cavity 109 does not touch the sensor 108 in this folded configuration to avoid vibrations scratching the lens or the cavity 109 is covered with a soft (e.g., felt, microfiber, etc.) lining. The third section 101C folds below the second section 101B and is closest to the ground when in the folded configuration also shown in FIG. 2.

According to at least one non-limiting exemplary embodiment, the cavity 109 formed in the middle section 101B of the tower 101 may have a concave interior surface with a radius of curvature that is approximately 2 millimeters to 10 millimeters larger than the outer radius of curvature of the dome-like shape of the 3D LiDAR sensor 108. This dimensional clearance defines an air gap between the interior surface of the cavity 109 and the exterior surface of the sensor 108 dome when the tower 101 is in its collapsed configuration (as shown in FIGS. 2 and 3), thereby preventing direct physical contact between the cavity 109 and the sensor 108 lens during transportation and storage. The interior surface of the cavity 109 may be lined with a shock-absorbing material, such as closed-cell foam, microfiber fabric, silicone rubber, or felt, having a thickness of approximately 1 millimeter to 5 millimeters, to further cushion the sensor 108 against vibrational forces encountered during shipping. In an alternative embodiment, the cavity may be formed in a portion of the base 106 rather than in the middle section 101B. In such an embodiment, the groove 110 of the base 106 may include a recessed pocket adjacent to the position where the 3D LiDAR sensor 108 rests when the tower 101 is collapsed, such that when the lower section 101A folds into the groove 110, the sensor 108 dome nests into the recessed pocket of the base 106. This alternative configuration may be desirable in embodiments where the 3D LiDAR sensor 108 is mounted at a lower position on the tower section 101A, closer to the base 106.

Since the second section 101B contains no protruding sensors, there is no need for complementary cavities to protect them on the third section 101C. However, in some exemplary non-limiting embodiments, the robot 100 may include a rear-facing sensors that also may be protected via a cavity in the second section 101B or third section 101C in a similar manner to cavity 109 protecting the 3D LiDAR 108 as shown.

The structural relationships among the components are clearly depicted, with the sections 101A, 101B, and 101C folding in a coordinated manner, and in an accordion fashion, to achieve the desired compactness. The folding mechanism is integral to this process, providing the necessary articulation at the joints to allow each section to fold onto the next. This design not only reduces the robot's 100 volume for easy transport but also ensures that the 3D LiDAR sensor 108 remains protected within the cavity 109, highlighting the innovative synergy between minimizing volume for portability and sensor protection.

According to at least one non-limiting exemplary embodiment, the user interface 107 may be placed on one of the tower sections 101A-C rather than the base 106. Preferably the interface 107, if placed on the tower, should be slightly below at head level for a typical operator (e.g., ~4 – 5 ft), wherein the precise tower section 101A-C the interface 107 would be placed on would depend on how tall the tower sections 101A-C are with respect to a comfortable height to view the screen. The optimal place for the user interface 107 in this embodiment may be within the tower section 101B or101C, on the opposite side of the 3D LiDAR sensor 108, and being slightly recessed into the tower. This would enable the tower, upon being folded, to also shield the user interface 107 screen from damage in a similar manner to the cavity 109 protecting the LiDAR 108 when the tower sections 101A-B are folded. There is, however, no need for a special cavity to protect the user interface 107 if it is recessed into the tower sections 101B-C as the interface 107 may only require a touch screen or small buttons that do not protrude outward from the tower sections 101B-C like the 3D LiDAR does.

Referring now to FIG. 4, the illustration depicts the collapsing a portion of tower 101 of the robotic system 100. As discussed above, the sections of the tower 101 are configured to fold at multiple locations, thereby minimizing the overall volume of the robot 100. The collapsable nature of the tower 101 ensures that it becomes flush with the base 106 of the robot 100, facilitating easy storage and transport (e.g., see FIG. 2). The embodiment shown in FIG. 4 illustrates a robot 100 being folded at different joints to illustrate the hinging mechanisms, and may not represent the operational state of the robot 100 shown in FIG. 1 nor the folded portable state shown in FIG. 2. In other words, the configuration shown in FIG. 4 is an intermediate stage of the robot 100 as it transforms from a fully extended state (FIG. 1) to a collapsed state (FIG. 2).

The lower section 101A serves as the foundational part of the tower 101, providing stability and support for the other sections. The middle section 101B connects the lower and upper sections 101A, 101C, respectively; allowing for a flexible folding mechanism that can accommodate the tower's collapse. The upper section 101C completes the structure of the tower 101, and when folded, it aligns with the other sections of the tower 101 to create a compact form.

In particular, FIG. 4 illustrates middle section 101B of the tower 101 pivots in a counterclockwise direction towards section (101A). As depicted by the arrow shown in FIG. 4, the middle section 101B rotates in a counterclockwise direction about axis y1 towards the lower section 101C. As section 101B pivots in a counterclockwise direction, the cavity 109 formed within it aligns with the sensor 108 formed in section 101A, allowing the cavity 109 to engage with and entirely encapsulate the sensor 108. This movement ensures that the sensor 108 is securely housed within the cavity, providing protection during the folding process.

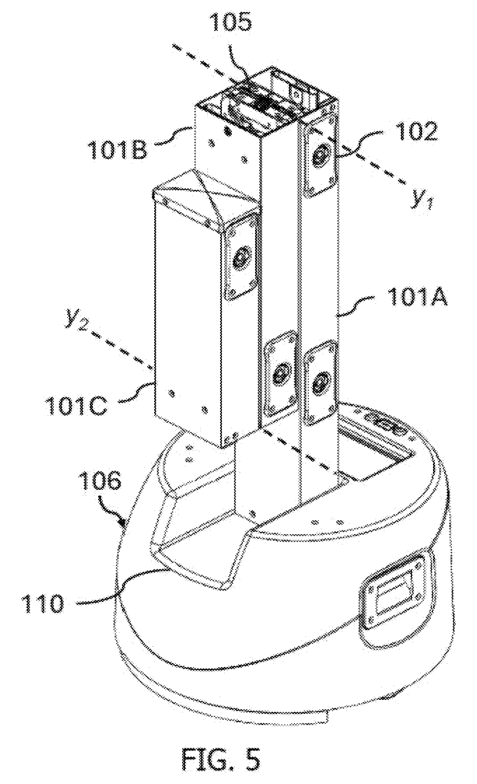

When moving from the operational state of the robot 100 (FIG. 1) to the portable state (FIG. 2), section 101C is folded first. This is due to the sections 101C and 101B, combined, being longer than the section 101A and would collide with the base of the robot 100. Next, the folded together sections 101C and 101B are folded onto the lower section 101A, such that the cavity (obstructed from view) covers the sensor 108, to produce the configuration shown in FIG. 5 below. To move robot 100 from the portable state to its operational state, the order is reversed.

While section 101B pivots counterclockwise towards section 101A about axis y1, section 101C simultaneously pivots clockwise towards section 101B about axis y2 as illustrated by the arrow in FIG. 2. This coordinated movement results in section 101B collapsing or folding onto section 101A, and section 101C collapsing or folding onto section 101B. Such coordinated movement of folding or collapsing of sections 101B and 101C may be achieved contemporaneously and simultaneously. The folding mechanism of the tower 101 at multiple points ensures that it can be stored in a compact manner, reducing shipping costs and enhancing the robot's 100 portability. The design also protects the 3D LiDAR sensor 108, which is crucial for the robot's 100 mapping and navigation capabilities. By folding the tower 101, the sensor 108 is safeguarded within a cavity 109 formed by the base 106, preventing damage during transportation and storage. Although shown and described with specific references to clockwise/counter-clockwise, one skilled in the art may appreciate that these rotations may be reversed without issue and are not intended to limit this disclosure.

Referring now to FIG. 5, the drawing illustrates a collapsable tower of a robotic system 100 designed for indoor mapping with the upper and middle sections 101C, 101B of the tower 101 being collapsed onto the lower section 101A while the lower section 101A is not in a collapsed configuration. At this stage of the configuration, section 101A of the tower 101 extends straight in a vertical direction from the base 106 of the robot, while section 101B is collapsed or folded onto section 101A, and section 101C is collapsed or folded onto section 101B. The robot is neither operational nor in its portable state in this illustrated configuration.

The tower sections 101A, 101B, and 101C represent distinct sections of the tower, each contributing to the folding mechanism that enables the tower to collapse efficiently. This sequential folding mechanism ensures that the tower becomes compact, reducing the robot's overall footprint for easy storage and transport. The folding mechanism is designed to protect the sensors, such as the 3D LiDAR sensor 108, by potentially housing them within a cavity 109 formed when the tower is collapsed.

In the folded configuration, section 101A is designed with a length that allows for an opening around its bottom portion, enabling it to fold down onto the base. This design ensures that when sections 101B and 101C of the tower 101 are folded onto section 101A, they do not occupy the entire length of section 101A, as shown in FIG. 5, allowing for efficient folding and compact storage.

The base 106 of the robot 100, which supports the collapsable tower 101, is designed to accommodate the folded sections, ensuring that the robot 100 remains stable and secure during transport. Specifically, the lower section 101A folds into the slot in the base 106 of the robot 100 and the two other sections 101B and 101C rest in front of the base and below the section 101A, as shown in FIG. 2. The integration of the tower 101 with the base 106 when folded further minimizes the volume. The drawing depicts the system's design by showcasing the structural components that enable the robot 100 to be compact and safeguard its sensors during transport, however it is appreciated that the robot 100 is neither in its operational nor portable state in the depicted configuration shown in FIG. 5. Instead, in FIG. 5, the robot 100 is in an intermediate stage wherein the sections 101C and 101B are collapsed and in parallel to section 101A as reflected by the axis y1 and y2.

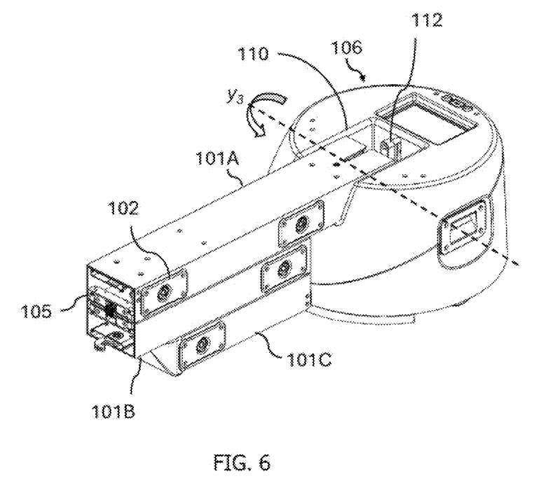

Referring now to FIG. 6, the illustration provides a detailed view of the robotic system's 100 collapsable tower 101 and its integration with the base 106, which is central to the focus on portability and sensor protection. Section 101A of the tower 101 folds or pivots in a counterclockwise direction, while sections 101B and 101C are already in their folded or collapsed stage once section 101A pivots in a counterclockwise direction. In particular, section 101A pivots in a counterclockwise direction with respect to axis y1 as illustrated by the arrow. In doing so, sections 101C and 101B pivot along with section 101A contemporaneously. In the folded or collapsed configuration, lower section 101A rotates over a top portion of the pin 112 that engages with the slot 113 formed in the lower most portion of the lower section 101A. The pin 112 may be released via a mechanical switch or input to a user interface. This folding capability is essential for reducing shipping costs and facilitating easy storage. The tower 101 is configured to integrate seamlessly with the base 106 when folded, ensuring a compact form factor. In some embodiments, the pin 112 may be locked and prevent folding of the tower sections 101 until the sections 101A-B are folded onto each other (e.g., as shown in FIG. 5).

In this final collapsed or folded configuration. section 101C of the tower is the closest to the floor, followed by sections 101B and 101A, respectively. This folding mechanism is crucial for enabling the tower to collapse efficiently, allowing it to become flush with the top of the base. This design not only minimizes the robot's volume but also ensures that the sensors, such as the 3D LiDAR, are protected during transportation. The folding mechanism may involve multiple joints, allowing the tower to fold at various points.

Overall, the components labeled in FIG. 6 interact to achieve the goals of portability and sensor protection. The collapsable tower, folding mechanism, and base work together to create a robotic system that is lightweight, transportable, and capable of efficient indoor mapping. The design ensures that the robot can be easily repositioned and stored, making it suitable for various applications, such as creating orthographic panoramic imagery and mapping indoor spaces.

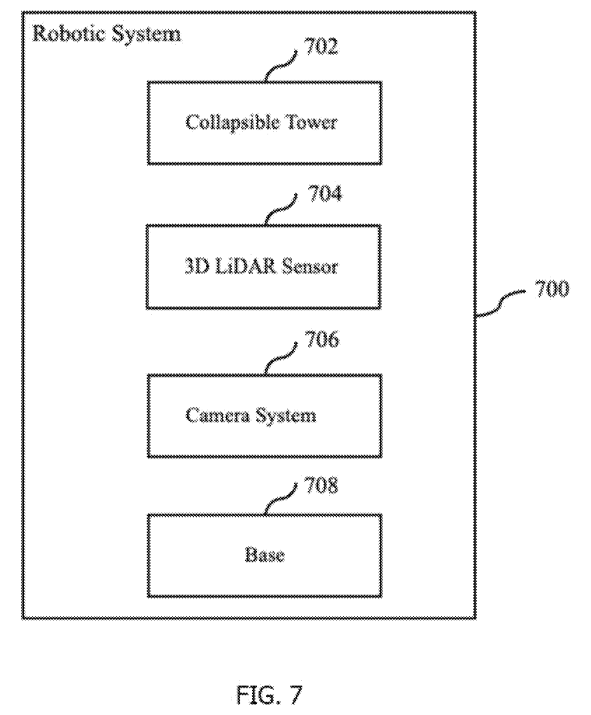

Next referring to FIG. 7, wherein a robotic system 100 with a collapsible tower is illustrated. The robotic system represented as 700 in this block diagram represents the robotic system 101 as discussed above with reference to FIG. 1. The collapsible tower component 702 may be designed to integrate with the base for enhanced portability. The tower may be collapsible at multiple joints, which may allow it to minimize the overall volume of the robot. This collapsibility may be facilitated by a folding mechanism, which may enable the tower to fold and become flush with the top of the base. This design may be intended to reduce the shipping costs by enabling the robot to occupy a low volume. The folding mechanism may be a sub-component that may allow the tower to collapse onto the base, thereby enhancing the portability of the robot.

The collapsible tower may be compatible with a transportation container for storage and shipping, which may further aid in its portability. In one exemplary embodiment, a robot 100 with a total height (i.e., base plus the tower) of 75 inches collapsed into a case that is 45 inches long, with additional 3 – 5 inches of padding surrounding the robot when stored in the case. This case could easily fit into most vehicles or be transported via mail at relatively low cost. The collapsible design may avoid including any unnecessary components that would contribute to the weight, such as task-specific actuators, thus maintaining the robot's 100 lightweight nature. Task specific modules may be provided separately, as discussed in more detail below. The tower 101 may also support a plurality of cameras 102 and a 3D LiDAR sensor 108, which may be used for capturing visual data and enabling orthographic views and panoramic stitching of objects. The cameras 102 may be disposed along the side of the tower 101, and the 3D LiDAR sensor 108 may be positioned on the front-facing side of the tower 101. The collapsible nature of the tower 101 may also ensure that the 3D LiDAR sensor 108 is protected during transport, as it may be housed within a cavity 109 formed within a section of the tower 101. This protection may be essential for maintaining the 3D LiDAR sensor's 108 functionality and preventing damage during transportation and storage.

The 3D LiDAR sensor 704 component may be integral to the robotic system's ability to navigate in and map its environment. The 3D LiDAR sensor 108 emits beams across a wide field of view along two axis such that objects in front, above, below (e.g., cliffs), and towards the sides of the robot 100 are detected and avoided. The 3D LiDAR 704 lens must protrude from the robot 100 body in order to emit beams for measuring distances into the environment. In some embodiments, the 3D LiDAR sensor 108 may be configured to sense a portion of the robot 100, such as the base 106. Assuming the 3D LiDAR sensor 108 does not move and remains in its factory calibrated position, the portions of the robot 100 sensed by the 3D LiDAR sensor 108 should remain at a static range due to the robot 100 and 3D LiDAR sensor 108 being in the same reference frame of motion. Detecting a deviation from the expected range(s) may enable the robot 100 to detect if the 3D LiDAR sensor 108 is uncalibrated, and possibly enable digital transformations onto the incoming data to correct for the misalignment.

According to at least one non-limiting exemplary embodiment, the self-calibration process performed by the 3D LiDAR sensor 108 may operate as follows. During an initial factory calibration, a processor of the robotic system 100 may store a set of reference range measurements corresponding to known static portions of the robot 100 body, such as the top surface of the base 106 or the front edge of the lower tower section 101A, as sensed by the 3D LiDAR sensor 108 from its factory-calibrated position. These reference range measurements may be stored in a non-transitory computer-readable memory accessible to the processor. During subsequent operation, the processor may periodically command the 3D LiDAR sensor 108 to capture a current set of range measurements to the same known static portions of the robot 100 body. The processor may then compute a difference between the current range measurements and the stored reference range measurements. If the computed difference exceeds a predetermined calibration threshold, such as 5 millimeters to 20 millimeters depending on the application tolerance, the processor may determine that the 3D LiDAR sensor 108 has shifted from its factory-calibrated position. In response, the processor may apply a corrective transformation, such as a rotation matrix or an affine transformation, to subsequent range measurements from the 3D LiDAR sensor 108 to compensate for the detected misalignment. Alternatively or additionally, the processor may generate a diagnostic alert, such as a visual notification on the user interface 107 or an audible alarm, indicating that the 3D LiDAR sensor 108 requires physical recalibration or service. This self-calibration approach advantageously enables the robotic system 100 to detect sensor drift or displacement that may occur during transportation, particularly after the tower 101 has been repeatedly folded and unfolded, thereby maintaining accurate mapping and navigation performance without requiring external calibration equipment.

Additionally, the 3D LiDAR sensor 108 may be protected by a cavity 109 when the robot 100 is in its portable configuration (shown in FIG. 2). This cavity 109 may serve to shield the sensor 108 during transport, by protecting the lens from scratches or other damages. This protective feature may be essential for a portable, frequently transported robot, thereby enhancing the robot's 100 versatility and reliability.

In summary, the 3D LiDAR Sensor component 704, along with its protective cavity 109, may play a role in the robotic system's self-calibration, diagnostics, and portability. The sensor's 108 design and integration with the collapsible tower 101 may enhance the robot's 100 functionality, durability, and ease of transport, making it a versatile tool for indoor mapping and other applications.

The camera system, identified as component 706, may be integral to the robotic system's functionality of capturing visual data of an environment. This visual data may be used for creating detailed maps of an environment, inventory analysis in warehouses or retail environments, or other feature detection applications. This system may include a plurality of cameras 102 strategically disposed along the side of the collapsible tower. These cameras 102 may be configured to capture visual data of objects as the robot drives past them. The roughly even spacing and tall height of the cameras enables orthographic views, generated via panoramic stitching of sequentially captured images, of the environment. Positioning the cameras 102 at a tall height above the floor may be essential for capturing orthographic imagery of similarly tall shelves/objects. The camera system may be designed to work in conjunction with the collapsible tower, which may be configured to fold at multiple joints, thereby minimizing the overall volume of the robot 100 for efficient transportation and storage. The folding mechanism may ensure that the tower 101 becomes flush with the top of the base 106, further aiding in volume reduction of the robot 100. This design may enable the robot 100 to occupy a low volume, thus reducing shipping costs and enhancing portability. The cameras' 102 placement along the tower 101 may be optimized to ensure that the visual data captured is comprehensive and suitable for the intended mapping tasks. The integration of the camera system with the collapsible tower 101 may exemplify the system's focus on portability and efficient data capture, aligning with the broader goals of the robotic system to navigate and map indoor environments effectively.

According to at least one non-limiting exemplary embodiment, the robotic system 700 may include various other exteroceptive sensor subsystems in addition to or in lieu of camera system 706, depending on the purpose of the robot 102. For instance, if the robot 100 is further configured to measure temperature, radio frequency identification (“RFID”) signals, or Wi-Fi signal strength throughout its environment, the robotic system 700 may further include thermometers, antennae, or other sensors to facilitate these tasks. That is, the use of cameras for the purpose of imaging objects for retail inventory tracking is an exemplary use of the portable robot design disclosed herein and is not intended to limit the disclosure. As another example, the robotic system 700 may be tasked with grabbing objects at tall shelves, thereby still necessitating a long/tall tower 101 which may be folded to maintain portability, wherein the actuators tasked with grasping objects may be installed in lieu of or in addition to the camera system 706. In some embodiments, the system may include one or more connection interfaces (e.g., ethernet cables, dovetail cables, coaxial cables, etc. as well as mechanical couplers) to enable the attachment of special purpose modules which perform these functions. For instance, an RFID reader may include a plurality of sensitive antennae, wherein it may be preferrable to transport the RFID reader separately from the robot 100 for its protection. Further, RFID may not always be utilized in every environment and thus an RFID reader may only be situationally useful. Accordingly, providing some form of connection interface for special-purpose sensors may improve the overall utility of the robot in identifying environmental features without increasing the cost or transport weight of the portable scanning robot 100.

According to at least one non-limiting exemplary embodiment, the one or more connection interfaces on the robotic system 100 may include a standardized mechanical mounting interface, such as a dovetail rail, a quick-release clamp, or a threaded mounting plate, disposed on one or more of the tower sections 101A, 101B, or 101C. The mechanical mounting interface may be configured to receive and securely retain an attachable sensor module, such as an RFID reader module, a thermal imaging camera module, a barcode scanner module, or an additional camera module. Each attachable sensor module may include a complementary mechanical coupling configured to mate with the mechanical mounting interface on the tower section. Additionally, each mechanical mounting interface may include an electrical connector, such as a standardized multi-pin connector, a USB-C port, or a proprietary power-and-data connector, that provides both electrical power from the robotic system's 100 onboard power supply and a data communication link to the computing unit housed in the base 106. This modular architecture enables the robotic system 100 to be reconfigured for different tasks or environments without requiring modification to the base robot hardware, and allows sensitive or mission-specific sensor modules to be transported separately from the robotic system 100 in their own protective packaging.

The base component 708 may serve as the foundational support for the robot 100, housing various integral components and facilitating the overall functionality of the system. The base 106 may be designed to support the collapsible tower 101, which integrates seamlessly with the base 106 to enhance portability. This integration may be achieved through a folding mechanism that allows the tower 101 to collapse onto the base (FIG. 2), thereby minimizing the robot's 100 overall volume. The base 106 may also contribute to the robot's 100 ability to autonomously navigate and localize within an environment, as it may house the necessary components for these functions such as actuators, brakes, wheels, and the like. Additionally, the base 106 may support the robot's 100 capability to traverse predefined or (pseudo-)random paths for mapping purposes. The circular design of the base 106 may allow the tower 101 to become flush with its top when folded, further optimizing the robot's 100 compactness for transport. This compact design may be crucial for reducing shipping costs and ensuring the robot's 100 portability. The base 106, in conjunction with the folding mechanism, may play a role in the robot's 100 ability to perform its intended functions efficiently while maintaining a low profile during transport and storage. The base of the robot 100 may further include a latching mechanism which secures the tower 106 upright and stationary (with respect to the base) during navigation. The robot 101 is a differential drive holonomic robot capable of turning in place. The holonomic nature of the differential drive in conjunction with the roughly circular base 106 enables to turn with no turning radius or reverse out of dead ends, improving its versatility in complex environments.

According to at least one non-limiting exemplary embodiment, the robotic system 100 may achieve autonomous navigation and localization using a combination of sensor data from the 3D LiDAR sensor 108 and odometry data from wheel encoders coupled to the differential drive wheels of the base 106. The processor of the robotic system 100 may execute a simultaneous localization and mapping (SLAM) algorithm, such as a variant of GMapping, Cartographer, or Hector SLAM, to construct a two-dimensional or three-dimensional occupancy grid map of the indoor environment in real time. The occupancy grid map may represent free space, occupied space, and unknown space as discrete cells, wherein each cell stores a probability value indicating the likelihood of occupancy. The processor may further execute a path planning algorithm, such as A-star, Dijkstra's algorithm, or a rapidly-exploring random tree (RRT) planner, to compute a collision-free trajectory from a current position to a target waypoint along a predefined or dynamically generated path. A motion controller, such as a proportional-integral-derivative (PID) controller or a model predictive controller (MPC), may translate the planned trajectory into velocity commands for the left and right differential drive wheels of the base 106. Additionally, a local obstacle avoidance module may utilize real-time range measurements from the 3D LiDAR sensor 108 to detect and avoid dynamic obstacles, such as humans, shopping carts, or forklifts, that were not present in the occupancy grid map. The robotic system 100 may store predefined paths as sequences of waypoints in the non-transitory computer-readable memory, wherein each waypoint comprises at least a two-dimensional coordinate (x, y) and an optional heading angle relative to the map coordinate frame.

According to at least one non-limiting exemplary embodiment, the base 106 of the robotic system 100 may house a computing unit comprising one or more processors, such as a central processing unit (CPU), a graphics processing unit (GPU), or a system-on-chip (SoC), communicatively coupled to a non-transitory computer-readable memory. The non-transitory computer-readable memory may include one or more of random-access memory (RAM), read-only memory (ROM), flash memory, a solid-state drive (SSD), or any combination thereof, and may store computer-readable instructions that, when executed by the one or more processors, cause the robotic system 100 to perform the operations described herein, including autonomous navigation, image capture and processing, self-calibration and diagnostics, and image quality assessment. The computing unit may further include one or more communication interfaces, such as a Wi-Fi transceiver, a Bluetooth transceiver, a cellular modem, or an Ethernet port, for transmitting captured images, sensor data, diagnostic reports, and status updates to a remote server or a local computing device. In some embodiments, the computing unit may include a dedicated real-time controller, such as a microcontroller or field-programmable gate array (FPGA), for time-critical motor control and sensor data acquisition. The computing unit may be powered by the same rechargeable battery that powers the differential drive motors, or by a separate power supply, depending on the design requirements.

The base 106 of the robot 100 may further include a user interface 107, as shown in FIG. 1 for example. The user interface may further include a touch screen or other interface for receiving user input, including selecting routes, inputting routes, deleting routes, and other commands. The user interface 107 may also include emergency stop buttons or switches which are readily accessible to humans to quickly stop the robot if necessary. According to at least one non-limiting exemplary embodiment, the base 106 may instead comprise a handle (e.g., 103) instead of the user interface 107 depicted in FIG. 1 – 6, wherein the user interface 107 may be instead placed on the tower sections 101A-C. This configuration enables lifting of the robot from a different angle, which may be preferable to some operators.

The robot 100 is equipped with wheels at the bottom of the base, enabling it to navigate or traverse along a route. These wheels can be of various types, such as caster wheels, which allow for smooth and multidirectional movement; actuated fixed position wheels (e.g., differential drive), which provide traction and locomotive force; or a combination thereof. Preferably the wheels are configured in a differential drive to maximize mobility by enabling the robot 100 to turn in place, wherein the cameras 102 are positioned directly above the differential drive axis to minimize translational movement as the base 106 rotates. The wheels and cameras 102 are strategically positioned to support the robot's weight and minimize image distortion caused by turning, contributing to the overall functionality and versatility of the robotic system to image various shelves and displays in a wide variety of environments. The differential drive also enables the robot 100 to turn around if it ever detects that it is stuck in a dead-end. Other systems of locomotion, such as treads, are considered and applicable to the present disclosure as well without limitation.

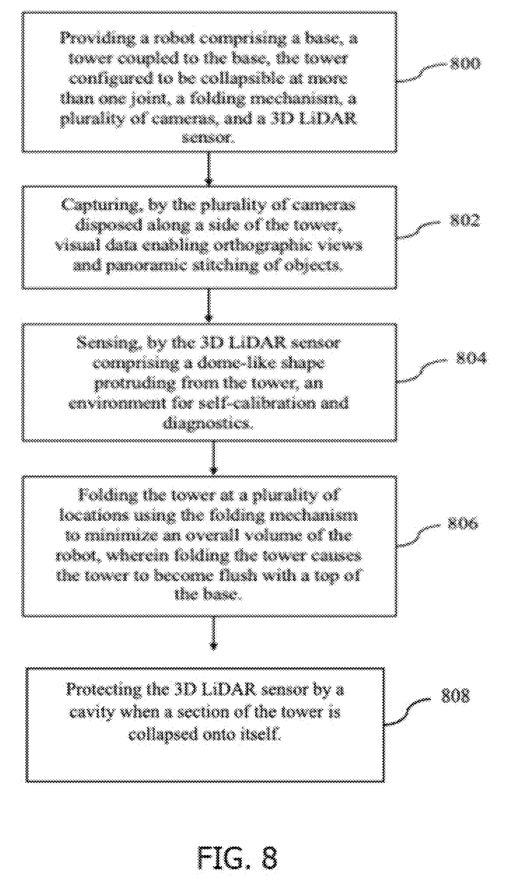

FIG. 8 is a flowchart illustrating a method in step 800 for providing a portable robotic system 101 for indoor mapping, according to an embodiment. At step 800, a robot 100 may be provided, comprising a base 106 and a tower 101 coupled to the base 106. The tower 101 may be configured to be collapsible at more than one joint, which may allow for the minimization of the overall volume of the robot 100. This collapsible design may be facilitated by a folding mechanism, such as hinges, pivots and other means as discussed above, which connect the various tower portions 101A, 101B, 101C.

The tower 101 may be further enabled to fold onto the base 106 and become flush with the top of the base 106 as shown in FIG. 2. The robot may also include a plurality of cameras 102 disposed along the side of the tower, which may be configured to capture visual data of the environment as the robot navigates. The vertical spacing of the side-facing cameras enables orthographic views via panoramic stitching of objects. A handle 103 may be included on either side of the base 106 to assist with lifting, picking up, and repositioning the robot 100, and the robot 100 may be compatible with a transportation container for storage and shipping. The collapsible design may enable the robot 100 to occupy a low volume, thus reducing shipping costs.

The folding mechanism may allow the tower 101 to collapse and fold onto the base 106, ensuring that the robot is easily stored in a carrying case for shipping. In some embodiments, the longest dimension of the carrying case is less than half of the tower 101 height due to the collapsable design. Additionally, a 3D LiDAR sensor 108 may be coupled to the tower at a height above the floor sufficient to detect hazards near the robot 100. The 3D LiDAR sensor 108 comprises a dome-like shaped lens which protrudes from the tower, and must be protected from damage to preserve the ability of the robot to safely navigate. The 3D LiDAR sensor 108 may be protected by a cavity when a section of the tower is collapsed onto itself in the portable state of the robot, ensuring the sensor is protected from scratches during transport. The cavity may be formed by a portion of the base when the tower is collapsed and may be configured to prevent damage to the 3D LiDAR sensor during transportation and storage. The cavity may be dimensioned to accommodate the dome-like shape of the 3D LiDAR sensor.

At step 802, the process may involve capturing visual data through a plurality of cameras 102 that are disposed along the side of the tower. These cameras 102 may be configured to enable orthographic views and panoramic stitching of objects by arranging the plurality of cameras 102 in a vertical arrangement such that the objects on the side of the robot are viewed from a substantially orthogonal perspective. The images may then be combined together, via for example image stitching, to form panoramic images. The cameras 102 may be evenly spaced along the side of the tower, which can facilitate consistent and uniform data capture.

According to at least one non-limiting exemplary embodiment, the robot 100 may only capture and store the images and, either via a live feed or batch upload, provide the images to an external processing device, such as a personal computer or remote server. The external device may perform the panoramic image construction in addition to, without limitation, distortion corrections, feature identification within the images, and other operations using the image data collected. Performing these tasks separately from the robot further enables additional simplification of the robot’s computational tasks.

The cameras' 102 configuration may be designed to optimize the field of view and ensure that the captured data is suitable for subsequent processing and analysis. The potential for orthographic views and panoramic stitching may enhance the robot's 100 ability to map indoor spaces efficiently. The design and arrangement of the cameras may be informed by the need to balance data capture capabilities with the robot's portability and ease of use.

In step 804, the process may involve utilizing the 3D LiDAR sensor 108 to sense the environment of the robot as the robot navigates. The 3D LiDAR sensor provides a plurality of range or distance measurements across a large field of view ahead of the robot, allowing it to detect, map, and avoid obstacles as well as track its position over time relative to nearby objects.

According to at least one non-limiting exemplary embodiment, the process may involve the sensing of a portion of the robot 100 by the 3D LiDAR sensor 108, which is characterized by its dome-like shape protruding from a front facing portion of the tower 101. This sensing capability may be utilized for self-calibration and diagnostics of the robot 100. The 3D LiDAR sensor 108 may be strategically positioned on the front-facing side of the tower 101, allowing it to effectively perform its sensing functions. The design and placement of the 3D LiDAR sensor 108 may facilitate the detection of the robot's own structure, which can be crucial for maintaining accurate calibration and performing necessary diagnostic checks. This configuration may ensure that the 3D LiDAR sensor 108 can operate without obstruction, thereby enhancing its ability to provide reliable data for the robot's 100 operational needs. The integration of the 3D LiDAR sensor 108 into the robot's system may contribute to the overall functionality and efficiency of the robot 100 in performing its intended tasks.

It is appreciated that steps 802 and 804 may be performed concurrently. That is, the robot may utilize its 3D LiDAR sensor 108 to navigate the environment safely while also capturing images of objects, such as shelves for inventory analysis.

At step 806, the process of folding the tower 101 at multiple locations using the folding mechanism, as discussed above, may be initiated to minimize the overall volume of the robot 100. This folding action may cause the tower 101 to become flush with the top of the base 106, thereby enhancing the robot's 100 portability and ease of storage. The tower 101 may be designed to fold at least at three distinct locations, which may involve a first section folding in a clockwise direction onto a second section, the second section folding in a counterclockwise direction with a third section, and the third section folding in a clockwise direction on the base 106. This folding sequence may be facilitated by the folding mechanism, which may be configured to enable the tower 101 to collapse and fold onto the base 106. The folding of the first section and the second section may be performed contemporaneously to each other.

The collapsable design of the tower 101 may contribute to the robot's 100 ability to occupy a low volume, which may reduce shipping costs and allow for efficient storage. The folding mechanism further includes a fold at the bottom of the tower 101 within a groove in the base of the robot 100, ensuring that the tower becomes flush with the top of the robot's 100 circular base when folded, further minimizing the volume occupied by the robot 100. This design may also ensure that the robot 100 remains lightweight and transportable, aligning with the overall goal of enhancing portability. The folding mechanism's operation may be crucial in achieving the desired compactness, which may be essential for the robot's 100 functionality in various environments. The collapsable tower 101, with its ability to fold at multiple locations, may thus play a role in the robot's design, ensuring that it can be easily transported and stored while maintaining its operational capabilities.

In the context of step 808, the process may involve the protection of the 3D LiDAR sensor 108 by a cavity 109 when a section of the tower 101 is collapsed onto itself. This step may be crucial in ensuring that the 3D LiDAR sensor 108, which is integral to the robot's functionality, remains undamaged during transportation and storage. A cavity 109 may be formed by a portion of the tower 101 when the tower 101 is collapsed, providing a secure enclosure for the sensor 108. This design consideration may be intended to prevent any potential damage to the 3D LiDAR sensor 108, which could occur due to external impacts or vibrations during transit that scratch the lens. The cavity 109 in the tower 101 may be specifically dimensioned to accommodate the dome-like shape of the 3D LiDAR sensor 108, ensuring a snug fit that minimizes movement and potential abrasion. This protective measure may be essential for maintaining the sensor's calibration and diagnostic capabilities, which are vital for the robot's 100 operation in mapping and navigation tasks. The integration of such a cavity 109 may reflect a thoughtful approach to sensor 108 protection, aligning with the broader goals of portability and functionality within the robotic system 100.

The method described with reference to FIG. 8, including steps 800 through 808, represents a specific technological improvement over conventional approaches to deploying, operating, and transporting indoor mapping robots. Unlike conventional methods that require an operator to manually attach and remove sensor covers before and after each deployment, the disclosed method leverages the coordinated folding sequence of the tower sections 101A, 101B, and 101C such that the protective cavity 109 automatically encapsulates the 3D LiDAR sensor 108 as a direct mechanical consequence of the folding action at step 806. This integration of sensor protection into the folding operation itself reduces deployment and retrieval time, eliminates the risk of an operator forgetting to attach a protective cover, and removes the need for separate protective accessories that could be lost or damaged. Furthermore, the self-calibration step performed during step 804, wherein the 3D LiDAR sensor 108 senses a known portion of the robot 100 body and the processor compares the measured range to a stored reference value, is a specific technological solution to the problem of sensor calibration drift that occurs during repeated folding, transportation, and unfolding cycles. This self-calibration process is not a generalized data-processing operation but rather a targeted mechanical and computational solution tied to the particular physical configuration of the robotic system 100 and the known geometric relationship between the 3D LiDAR sensor 108 and the base 106.

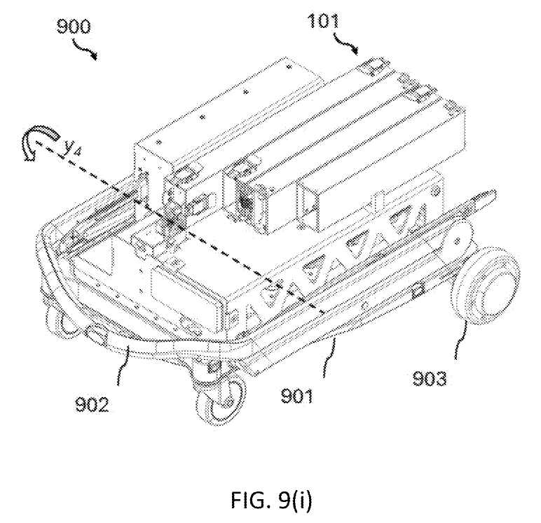

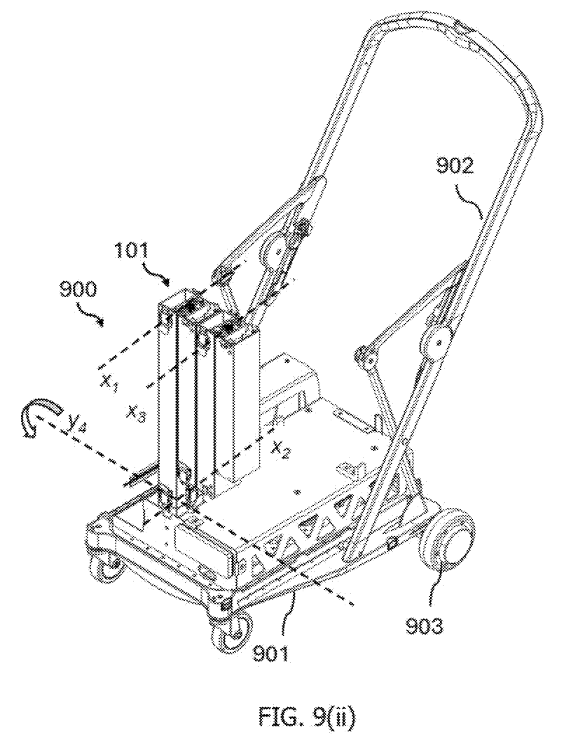

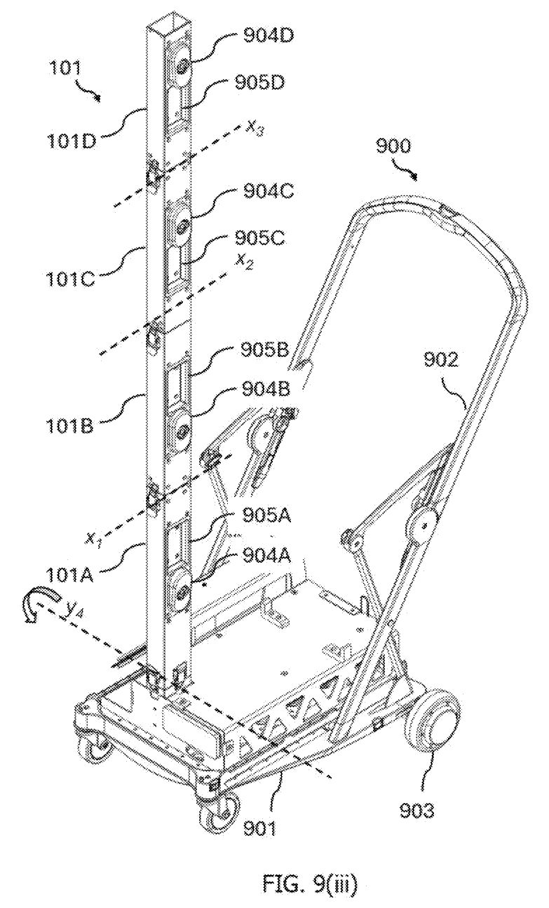

Next, FIGS. 9(i)-(iii) will be discussed in detail which represents another embodiment of the robotic system illustrated in FIG. 1 that is retrofitted onto a pushcart. Similar to the robotic system of FIG. 1, this embodiment of the robotic system can include a collapsible tower 101 integrated with a base 901, designed to minimize the overall volume of the robot 900. The tower 101 can fold at multiple joints, allowing it to collapse on top of the base 901, which may protect sensors such as cameras and a 3D LiDAR sensor. And, similar to the robotic system of FIG. 1, this embodiment of the robotic system 900 may also include a plurality of cameras along the tower, capturing visual data for orthographic views and panoramic stitching, and providing image quality feedback to adjust the robot's route.

In some embodiments, the robotic system 900 may autonomously navigate and localize within an environment, traverse predefined paths for mapping, and be compatible with a transportation container for storage and shipping. One or more sensors, such as the 3D LiDAR 108 shown in the above examples, or other exteroceptive sensors may be affixed to the tower if autonomous navigation is desired. By the tower 101 folding down onto the base 901 of the robot as shown in FIG. 9(i), the sensors are be protected. Additionally, the tower 101 in this illustrated embodiment folds over the plurality of cameras to protect their lenses. The robotic system 900 may be lightweight and transportable, with a handle 902 for lifting and repositioning, and can operate autonomously, semi-autonomously, or manually.

Referring to FIG. 9(i), illustrates a robotic system 900 designed with a base 901, which serves as a platform for supporting additional components. This base 901 is integral to the system's functionality, providing a stable foundation for the collapsible tower 101 and integrated sensors. The base 901 in this embodiment is a pushcart, which may allow for manual maneuvering or (semi-)autonomous operation via the use of motorized wheels 903. This design aligns with the description of a system that can be both transportable and adaptable for various operational modes. The base 901 may include a cavity that protects the sensors when the tower 101 is folded. This cavity can prevent damage during transportation and storage, ensuring the system's durability and reliability. The handle 902 is a component for manual operation, allowing users to lift, pick up, and reposition the robotic system 900 as needed. This feature enhances the system's portability and ease of use, making it compatible with transportation containers for storage and shipping. The handle's design may also facilitate the transition between manual and autonomous modes, providing flexibility in various environments.

The tower 101 in the illustrated embodiment includes four sections which fold onto each other to protect the cameras thereon. To unfold the tower, first the four tower sections are rotated about an axis of rotation y4 via the use of a hinge or joint which locks the tower sections vertically into place, as shown next in FIG. 9(ii). If the robot 100 is further desired to be manually maneuvered via the handlebars 902, the handlebars 902 may also be extended as shown in FIG. 9(ii). Overall, the components depicted in FIG. 9(i) interact to create a cohesive robotic system that can navigate, map, and operate efficiently within its intended environment.

Next, FIG. 9(ii) is discussed. This figure illustrates the robotic system 900 designed with a portion of the collapsible tower 101 in a partially extended configuration as it sits on top of the pushcart base 901. The handle 902 of the pushcart is in an extended configuration that is strategically positioned to assist users in guiding the robotic system 900, allowing the system to be operated manually or semi-autonomously. The tower 101 in this embodiment is similar to the tower 101 discussed above with respect to FIGS. 1-6, although in the illustrated embodiment the tower 101 includes four foldable sections and folds onto the base 901 of the robot perpendicular to the axis of rotation of the individual tower sections. As shown in FIG. 9(ii), the four tower 101 sections fold out from the base along the y4 axis and, once unfolded each tower section unfolds perpendicularly along three x1-3 axis.

Lastly, FIG. 9(iii) depicts the robot 100 with the tower 101 fully extended. As shown from this view, the tower 101 includes four distinct sections, labeled 101A-D. Each respective tower section 101A-D includes a camera 904A-D and a cavity 905A-D. The respective cavities 905A-D in this embodiment are configured to protect the respective camera 904A-D of a neighboring tower section which folds onto each other.

Specifically, to fold the tower 101 back into the configuration shown in FIG. 9(ii), section 101D folds clockwise around the x3 axis such that the camera 904D enters the cavity 905C. This folding also causes the camera 904C to enter the cavity 905D. These two sections, now having neither camera 904C nor 904D exposed, then fold counterclockwise around the x2 axis and onto the back side of section 101B. Section 101B, along with the two folded sections 101C-D, then folds clockwise around x1 axis such that its camera 904B enters the cavity 905A and the camera 904A enters the cavity 905B. With all four tower sections 101A-D now folded, none of the cameras 904A-D are exposed as shown in FIG. 9(ii). Unfolding the robot 100 involves the inverse rotations. Specifically, starting from the configuration shown in FIG. 9(ii), sections 101B-D unfold counterclockwise around x1, followed by sections 101C-D clockwise unfolding around x2, and lastly section 101D unfolding counterclockwise around x3.

Advantageously the use of an extendable tower on a push cart base 901 enables manual scanning of objects and features within environments which is customizable to human needs. By providing the push-cart base, the robot is able to be positioned nearby objects, shelves, products, etc. to be imaged by a human operator without the need for generating a map of the space.

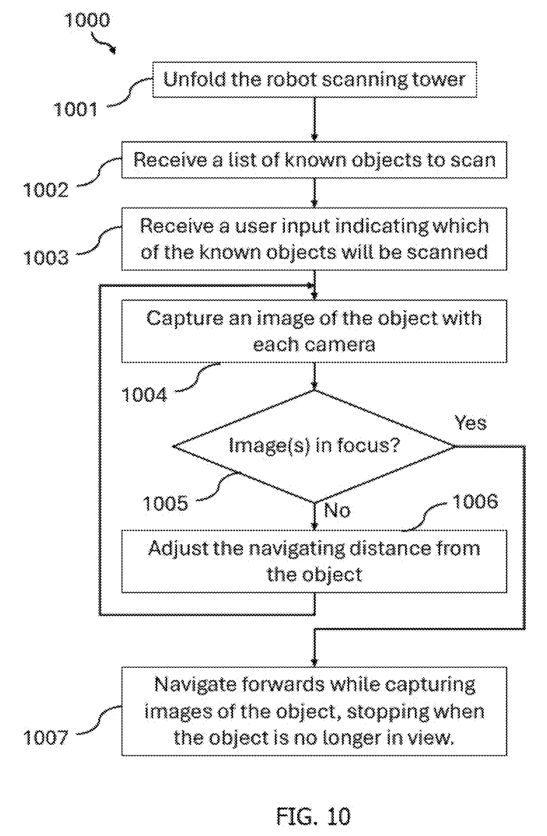

FIG. 10 is a process flow diagram illustrating a method 1000 for operating a portable robot 100 disclosed herein to scan for features within an environment. It is appreciated that the steps of method 1000 may be effectuated via a processor of the robot executing instructions from a non-transitory computer readable memory that comprises computer readable instructions.

Block 1001 begins with the robot 100 having its tower 101 unfolded. The tower may be unfolded as described in FIG. 1 – 6 and FIG. 9(ii-iii) above. A human operator may unfold the tower or the joints may be motorized and unfold automatically.

Block 1002 includes the robot 100 receiving a list of known objects to scan. For example, the robot 100 may be deployed to scan shelves in a grocery store for inventory analysis, wherein the list of known objects may comprise a list of aisles, planograms, or shelves (e.g., “grocery 1 produce”) which are in the store. By providing the robot 100 with only a finite list of known objects to be scanned, the requirement that the overall environment be spatially mapped and detected by the robot 100 is removed. The robot 100 may, instead of identifying locations where images are taken on a 2D or 3D map, may instead simply correspond the images taken to a known object from a finite list, wherein inventory analysis insights are tied to that object rather than an (x, y) position in the overall environment.

Block 1003 includes the robot receiving a user input indicating which object from the list of known objects will now be scanned. A human operator may, accordingly, place the robot 100 proximate to the known object in the environment and select the respective known object from the list. If the object requires multiple successive images to capture fully, such as a long shelf in a store, the robot 100 should be placed near the edge of the object with its cameras facing towards it.

Block 1004 includes the robot 100 capturing an image. If the robot 100 includes a plurality of cameras, all of its cameras may capture an image contemporaneously. The image should include at least some features of the object. The robot 100 may begin block 1004 of method 1000 following a user input to command the robot 100 to begin scanning the selected object.

Block 1005 includes the robot 100 determining if the image(s) are in focus. Any contemporary image analysis method may be utilized for this analysis. For example, when scanning inventory in stores or warehouses, barcodes may provide a unique target for image quality analysis. Due to their high contrast (black/white) and use of straight lines, or perfect squares in the case of quick response (“QR”) codes, the image quality may be assessed via detection of grey pixels, due to poor resolution, or non-straight lines, due to blurriness causing lines to be unresolved. Other methods such as Laplacian filters/variance, machine learning models, and the like may be utilized without limitation.

According to at least one non-limiting exemplary embodiment, the image quality determination at block 1005 may be performed by the processor of the robotic system 100 applying a Laplacian operator to each captured image. Specifically, the processor may convolve a grayscale version of the captured image with a Laplacian kernel, and then compute the variance of the resulting filtered image. A high variance value indicates that the image contains sharp edges and is in focus, while a low variance value indicates that the image is blurry. The processor may compare the computed variance against a predetermined focus threshold stored in the non-transitory computer-readable memory of the robotic system 100. If the variance falls below the focus threshold, the processor may determine that the image is not in focus and trigger the distance adjustment at block 1006. In another embodiment, the processor may detect barcodes or QR codes within the captured image using a barcode detection library and assess whether the detected code boundaries consist of straight, high-contrast lines. If the detected lines exhibit curvature beyond a threshold degree or if the contrast ratio between the black and white elements of the barcode falls below a predetermined contrast threshold, the processor may determine that the image lacks sufficient resolution or focus. In yet another embodiment, a pre-trained machine learning model, such as a convolutional neural network (CNN) trained on a dataset of in-focus and out-of-focus shelf images, may receive the captured image as input and output a confidence score indicating the probability that the image is in focus. The processor may compare this confidence score against a predetermined threshold to make the focus determination.

Upon the robot 100 determining the captured image(s) are not in focus, the process moves to block 1006.

Upon the robot 100 determining the captured image(s) are in focus, the process moves to block 1007.

Block 1006 includes the robot 100 adjusting its navigating distance from the object. If the image is blurry, it is likely due to the focal length of the cameras not aligning with the distance of the robot 100 to the object. Accordingly, the robot 100 may either increase or decrease its distance from the object until the blur is below a threshold amount, as shown by the loop between blocks 1004-1006.

According to at least one non-limiting exemplary embodiment, the robot 100 may comprise a manual pushcart as shown in FIG. 9(i-iii) above, wherein the adjustment of the navigating distance may be requested by the robot via a user interface and effectuated via a human operator manually maneuvering the robot 100 into a more desirable position to capture quality images.

Block 1007 includes the robot 100 navigating forwards while capturing images of the object with its one or more cameras. The robot 100 may continue navigating forwards until the object is no longer detected. The object may be determined to be out of detection upon, for example, an exteroceptive sensor, such as a 3D LiDAR 108, no longer detecting the object or via image analysis by detecting the edges of shelves, warehouse racks, pallets, or other objects being scanned.

Method 1000 enables the portable robots 100 disclosed herein to be deployed at will to any known object without the need for prior localization within the environment or prior maps thereof. Furthermore, due to the image quality determining the robot’s distance to the shelf, minimal human involvement is required to initialize the robot 100 in a new environment to scan an object properly, thus furthering the ability of the portable robot 100 to be deployed in a wide variety of environments by minimizing the setup time and effort.

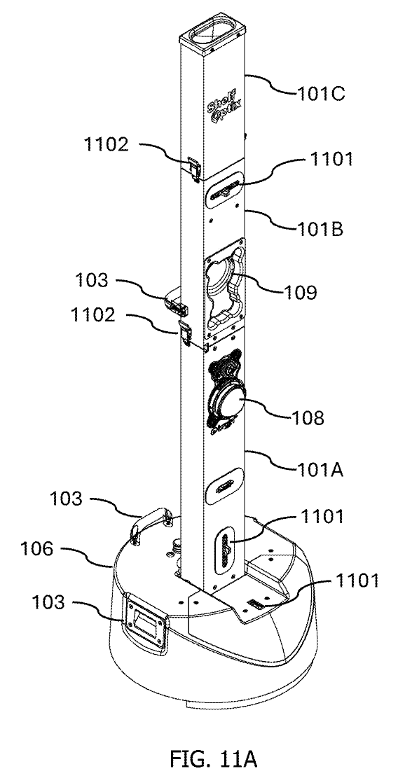

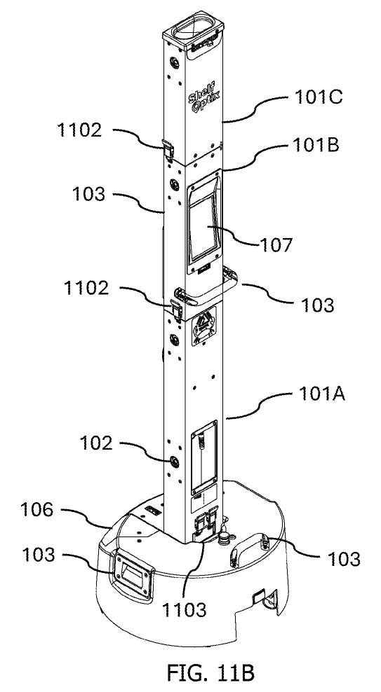

FIGS. 11A-B depict an alternative embodiment for the portable scanning robot 100 described above. First, FIG. 11A is an isometric view of the front side of the portable robot 100. The 3D LiDAR 108 is still positioned on the tower section 101A just below the tower section 101B which contains the protective cavity 109 as described in other embodiments of the portable robot 100 above. The location of this sensor 108 remains the same as the prior embodiments, wherein the sensor 108 protrudes from the tower section 101A to sense the surrounding environment, including a portion of the robot 100 base 106. The tower section 101B is configured to be folded onto the section 101A such that the cavity 109 encapsulates the sensor lens 108, preferably with a small air gap or soft lining (e.g., microfiber) to avoid vibrations scratching the lens, as shown in FIG. 2. The tower sections 101 include cameras 102 which are obscured from view in this perspective view.

The robot 100 depicted in FIG. 11A differs from prior embodiments in the position of its handles 103, user interface 107, and mechanical latches 1101, 1102 used to secure the tower in upright or folded states. In addition to the handles 103 positioned on opposite sides of the base 106, another handle 103 is placed on top of the base. The handle 103 on top of the base 106 is orthogonal to the handles 103 on the side of the base 106. The side handles 103 may enable a two-handed pickup of the robot 100 while the additional handle on the base 103 may enable picking up of the robot 100 from the top. Some operators may prefer this method of lifting the robot 100 as it lessens the need of the operator to squat low to grasp the handles 103 – but may require a stronger single-arm lift. Additionally, the tower section 101B now also includes a handle 103 positioned roughly at human chest level (~4 to 5 feet above the floor) to enable the robot to be manually pushed easily while the tower sections 101 are fully extended. This handle may be detachable to avoid preventing the tower sections 101B and 101C from folding. Advantageously this additional tower handle allows operators to quickly push the robot 100 to new destinations without programming a route to travel there or folding the robot 100 in between each use.

Furthermore, the embodiment of the portable robot 100 includes two separate latching systems to secure the tower sections 101A-C in their upright or folded configuration. Latches 1101 ensure the tower sections 101, when folded onto each other or onto the base 106, remain secured in their folded state. These latches 1101 may comprise pressure release latches configured to be disengaged upon a threshold amount of force pushing the tower sections 101 apart, but would remain engaged unless that force is applied. The force should be greater than any force caused by vibrations during transportation while still enabling any human of any strength level to separate them quickly and easily. Additionally, external latches 1102 hold the tower sections 101A-C in their upright state and are not released unless a human manually releases the latch. When the latches 1102 are disengaged, the tower sections 101 may be folded without resistance, however when they are engaged they should not enable any rotations of the tower sections 101A-C even if force is applied. This ensures that the robot 100, while operating, will not be accidentally folded if force is applied to a tower section 101A-C (e.g., a person bumping into the robot 100). While being transported, the robot 100 may be placed in a carrying case which prevents unfolding of the tower sections 101A-C. Accordingly there is no requirement for the same manually engaged latches 1102 for securing the tower sections 101A-C in their folded state. These latches 1102 may replace the pin lock 112, 113 shown in FIG. 2.

According to at least one non-limiting exemplary embodiment, the folded-state latches 1101 may each comprise a spring-loaded ball detent or a magnetic catch, wherein a spring-biased ball or magnetic element engages a corresponding receptacle or ferromagnetic surface on the adjacent tower section when the sections are folded together. The spring constant or magnetic holding force may be selected such that the holding force exceeds forces generated by normal shipping vibrations, which may range from approximately 0.5 G to 3 G depending on the transportation mode, while remaining low enough that a human operator can separate the tower sections 101A, 101B, and 101C by hand without tools. The upright-state latches 1102 may each comprise a manually actuated over-center latch, a cam lock, or a toggle clamp, mechanically fastened to the exterior surface of adjacent tower sections 101A, 101B, and 101C. Each upright-state latch 1102 may include a lever arm that an operator rotates to engage or disengage the latch. When engaged, the upright-state latch 1102 may create a rigid mechanical connection that resists rotation about the respective y-axis pivot joint, thereby preventing accidental folding of the tower 101 during operation even under external impact forces. A groove 1103 near the base of the tower section 101A may have a width of approximately 5 millimeters to 15 millimeters and a depth of approximately 3 millimeters to 8 millimeters, providing sufficient clearance to prevent an operator's fingers from being pinched between the tower section 101A and the base 106 during the folding or unfolding operation.

Next, FIG. 11B depicts an isometric view of the robot 100 shown in FIG. 11A from the rear-view, according to the exemplary embodiment. From this perspective, the user interface 107, disposed on the middle tower section 101B and comprising a touch screen, is clearly visible and placed just above the tower handle 103. As discussed above, the handle 103 on the tower section 101B is roughly at chest level, wherein the user interface 107 is positioned roughly at or just below eye level. This placement of the user interface 107 may be easier for a robot operator to interact with while the tower 101 is in its extended position. The interface 107 is tilted upwards to enable easier viewing. The interface 107 on the tower section 101B may replace the interface 107 on the base to reduce cost, or both may be present in other embodiments. The interface 107 is recessed slightly into the tower to protect the screen from damage during transportation.

The tower sections 101A-C fold onto each other in an alternating pattern in the same manner as shown in FIG. 4. Specifically, section 101C folds onto and over the user interface 107 (i.e., towards the viewer of FIG. 11B). This protects the user interface 107 from being scratched or damaged during transport similarly to how the cavity 109 protects the sensor 108 lens. The two folded sections 101C and 101B then fold onto the bottom section 101A in the opposite direction (i.e., away from the viewer of FIG. 11B).

Although shown as a touch screen, one may appreciate that analog controls may be used in lieu of touch screens for the interface 107, wherein similarly recessing them into the tower section 101B offers similar protection during transportation.

Lastly, the robot 100 in FIG. 11B further includes a small groove near the base of the tower section 101A to prevent operator fingers from being pinched while the tower 101 is extended or collapsed.

The instant description is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a”, “an”, and “the” include plural referents unless the context clearly dictates otherwise. Thus, for example, reference to a “body” includes aspects having two or more bodies unless the context clearly indicates otherwise.

Ranges can be expressed herein as from “substantially” or “about” one particular value, and/or to “about” or “substantially” another particular value. When such a range is expressed, another aspect includes from the one particular value and/or to the other particular value.

Similarly, when values are expressed as approximations, by use of the antecedent “substantially” or “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A robotic system for indoor mapping, comprising:
a base comprising a differential drive having a wheel axis;
a tower coupled to the base and comprising a plurality of tower sections including a lower section and at least one upper section, the tower being collapsible at a plurality of joints between adjacent tower sections;
a folding mechanism configured to fold the tower from an extended configuration into a collapsed configuration in which the tower lies substantially flush with a top of the base;
a plurality of cameras mounted to the tower along a line that is vertically aligned with the wheel axis, the plurality of cameras being oriented substantially perpendicular to a direction of travel of the robotic system such that rotation of the base about the wheel axis causes the plurality of cameras to rotate in place without substantial lateral translation of corresponding fields of view;
a three-dimensional (3D) LiDAR sensor mounted to the robotic system;
a memory comprising computer readable instructions stored thereon; and
at least one processor configured to execute the computer readable instructions to cause the robotic system to:
obtain image data from the plurality of cameras while the robotic system traverses a path adjacent to one or more objects; and
obtain range data from the 3D LiDAR sensor while the robotic system traverses the path.

2. The robotic system of claim 1, further comprising:
a cavity is formed in one of the tower sections, and
wherein,
the 3D LiDAR sensor is mounted to a front-facing side of the tower and has a dome-like shape that protrudes outward from the tower; and
the cavity is positioned such that, in the collapsed configuration, the cavity at least partially receives the dome-like shape of the 3D LiDAR sensor to protect the 3D LiDAR sensor during transportation and storage.

3. The robotic system of claim 1, wherein the instructions further cause the at least one processor to generate an orthographic composite image of the one or more objects by concatenating pixel regions extracted from a plurality of captured images, each pixel region corresponding to a central band of an image captured at substantially normal incidence.

4. The robotic system of claim 1, wherein the instructions further cause the at least one processor to:
identify keypoints in overlapping regions of the image data captured by at least one of the plurality of cameras;
compute a geometric transformation based on the keypoints; and
generate a panoramic image of the one or more objects by aligning and blending the image data according to the geometric transformation.

5. The robotic system of claim 1, wherein the instructions further cause the at least one processor to:
cause the plurality of cameras to capture an image of at least one object at a current distance;
determine a focus metric of the image using a Laplacian-based variance calculation or a trained machine learning model;
compare the focus metric to a focus threshold; and
in response to the focus metric being below the focus threshold, adjust a navigating distance between the robotic system and the at least one object and cause the plurality of cameras to recapture the image.

6. The robotic system of claim 1, wherein:
the memory stores reference range measurements associated with at least one known static portion of the robotic system; and
the instructions further cause the at least one processor to:
obtain range data from the 3D LiDAR sensor including range measurements to the at least one known static portion of the robotic system;
compare the range measurements to the reference range measurements;
determine, based on the comparison, whether the 3D LiDAR sensor is misaligned relative to the base; and
in response to determining that the 3D LiDAR sensor is misaligned, apply a corrective transformation to subsequent range data or generate a diagnostic alert indicating a calibration condition.

7. A method for operating a robotic system for indoor mapping, the method comprising:
providing a robotic system comprising:
a base comprising a differential drive having a wheel axis,
a tower coupled to the base and comprising a plurality of tower sections including a lower section and at least one upper section, the tower being collapsible at a plurality of joints between adjacent tower sections,
a folding mechanism configured to fold the tower from an extended configuration into a collapsed configuration in which the tower lies substantially flush with a top of the base,
a plurality of cameras mounted to the tower along a line that is vertically aligned with the wheel axis, the plurality of cameras being oriented substantially perpendicular to a direction of travel of the robotic system such that rotation of the base about the wheel axis causes the plurality of cameras to rotate in place without substantial lateral translation of corresponding fields of view,
a three-dimensional (3D) LiDAR sensor mounted to the robotic system, and
a memory comprising computer readable instructions stored thereon;
navigating the robotic system along a path adjacent to one or more objects while the tower is in the extended configuration;
obtaining, by the plurality of cameras, image data of the one or more objects while the robotic system traverses the path; and
obtaining, by the 3D LiDAR sensor, range data while the robotic system traverses the path.

8. The method of claim 7, wherein the robotic system further comprises:
a cavity formed in one of the tower sections, and
wherein,
the 3D LiDAR sensor is mounted to a front-facing side of the tower and has a dome-like shape that protrudes outward from the tower; and
the cavity is positioned such that, in the collapsed configuration, the cavity at least partially receives the dome-like shape of the 3D LiDAR sensor to protect the 3D LiDAR sensor during transportation and storage.

9. The method of claim 7, further comprising:
generating, by at least one processor executing the computer readable instructions, an orthographic composite image of the one or more objects by concatenating pixel regions extracted from a plurality of captured images, each pixel region corresponding to a central band of an image captured at substantially normal incidence.

10. The method of claim 7, further comprising, by at least one processor executing the computer readable instructions,
identifying keypoints in overlapping regions of the image data captured by at least one of the plurality of cameras;
computing a geometric transformation based on the keypoints; and
generating a panoramic image of the one or more objects by aligning and blending the image data according to the geometric transformation.

11. The method of claim 7, further comprising, by at least one processor executing the computer readable instructions:
causing the plurality of cameras to capture an image of at least one object at a current distance;
determining a focus metric of the image using a Laplacian-based variance calculation or a trained machine learning model;
comparing the focus metric to a focus threshold; and
in response to the focus metric being below the focus threshold, adjusting a navigating distance between the robotic system and the at least one object and causing the plurality of cameras to recapture the image.

12. The method of claim 7, wherein,
the memory stores reference range measurements associated with at least one known static portion of the robotic system; and
the method further comprises, by at least one processor executing the computer readable instructions:
obtaining range data from the 3D LiDAR sensor including range measurements to the at least one known static portion of the robotic system;
comparing the range measurements to the reference range measurements;
determining, based on the comparison, whether the 3D LiDAR sensor is misaligned relative to the base; and
in response to determining that the 3D LiDAR sensor is misaligned, applying a corrective transformation to subsequent range data or generating a diagnostic alert indicating a calibration condition.

13. The method of claim 7, further comprising folding the tower from the extended configuration into the collapsed configuration using the folding mechanism, wherein folding the tower causes the tower to become flush with the top of the base.

14. The method of claim 13, further comprising protecting the 3D LiDAR sensor during transportation and storage, wherein folding the tower causes a cavity formed in one of the tower sections to automatically move over at least a portion of the 3D LiDAR sensor.
